(19) United States
(12) Patent Application Publication
(10) Pub. No.: US 2026/0099941 A1
(43) Pub. Date: Apr. 9, 2026

(54) THREE-DIMENSIONAL SCANNER

(71) Applicant: Keyence Corporation, Osaka (JP)

(72) Inventors: Woobum KANG, Osaka (JP); Yohei IWASAKI, Osaka (JP)

(73) Assignee: Keyence Corporation, Osaka (JP)

(21) Appl. No.: 19/314,056

(22) Filed: Aug. 29, 2025

(30) Foreign Application Priority Data
Oct. 7, 2024 (JP) 2024-175780

(51) Int. Cl. G06T 7/73; H04N 13/254

(52) U.S. Cl. CPC G06T 7/73; H04N 13/254; G06T 2207/30204

(57) ABSTRACT

A three-dimensional scanner includes a data acquisition unit that acquires a light reception signal based on measurement light reflected by a holding member and a workpiece and acquires a two-dimensional image including an identification member provided on the holding member, a three-dimensional data generation unit that generates first three-dimensional data including pieces of three-dimensional data of the holding member and the workpiece based on the light reception signal, an estimation unit that specifies a position posture of the identification member based on the two-dimensional image acquired by the data acquisition unit, and estimates a position posture of the holding member based on the position posture of the identification member, and a three-dimensional data editing unit that generates second three-dimensional data obtained by removing the three-dimensional data of the holding member from the first three-dimensional data based on the position posture of the holding member.

### CROSS-REFERENCE TO RELATED APPLICATIONS

The present application claims foreign priority based on Japanese Patent Application No. 2024-175780, filed October 7, 2024, the contents of which are incorporated herein by reference.

### BACKGROUND OF THE INVENTION

### Technical Field

The disclosure relates to a three-dimensional scanner that generates three-dimensional data of a workpiece.

### Description of the Related Art

For example, JP2024-24328A discloses a three-dimensional scanner that scans a workpiece mounted on a stage to generate three-dimensional data.

This type of three-dimensional scanner is configured to be able to measure the three-dimensional shape of the workpiece by irradiating the workpiece on the stage with mainly structured illumination light and imaging and analyzing distortion of the illumination light by a camera.

Incidentally, in the three-dimensional scanner as disclosed in JP2024-24328A, it is necessary to hold a posture of the workpiece on the stage such that a portion of the workpiece whose shape is to be measured falls within a field of view of the camera. For example, in a case where the measurement is performed in a standing posture of the workpiece, it is conceivable that the workpiece is held by a holding member so as not to fall on the stage, but since such a holding member is also measured together with the workpiece, it is necessary to remove three-dimensional data of the holding member after the measurement, which is complicated. In particular, in a case where the workpiece is captured a plurality of number of times, it is necessary to remove the three-dimensional data of the holding member for each capturing, which is particularly complicated.

Therefore, for example, it is conceivable to apply a method for reading CAD data of the workpiece in advance and automatically erasing measurement data in which a difference between the CAD data and the measurement data is equal to or more than a certain value. However, in this method, it is necessary to prepare CAD data and it is necessary to perform alignment between the CAD data and the measurement data for each capturing. Therefore, even though this method is adopted, a complicated work is required. Although it is conceivable to automatically perform the above-described alignment between the CAD data and the measurement data, since the measurement data includes the unnecessary three-dimensional data of the holding member, a success rate of the alignment is lowered, and eventually, a complicated work is required.

### SUMMARY OF THE INVENTION

The disclosure has been made in view of such a point, and an object of the disclosure is to reduce a burden on a user by enabling automatic removal of three-dimensional data of a holding member in a case where a workpiece held by the holding member is measured.

In order to achieve the above object, according to one embodiment of the disclosure, a three-dimensional scanner that irradiates a workpiece with measurement light from a light projection unit and generates three-dimensional data of the workpiece based on the measurement light reflected by the workpiece can be premised. A three-dimensional scanner includes a holding member that holds the workpiece, an identification member that is provided on the holding member and specifies a position posture of the holding member, a data acquisition unit that acquires a light reception signal based on the measurement light reflected by the holding member and the workpiece and acquires a two-dimensional image including the identification member provided on the holding member, a three-dimensional data generation unit that generates first three-dimensional data including pieces of three-dimensional data of the holding member and the workpiece based on the light reception signal acquired by the data acquisition unit, an estimation unit that specifies a position posture of the identification member based on the two-dimensional image acquired by the data acquisition unit, and estimates a position posture of the holding member based on the specified position posture of the identification member, and a three-dimensional data editing unit that generates second three-dimensional data obtained by removing the three-dimensional data of the holding member from the first three-dimensional data generated by the three-dimensional data generation unit based on the position posture of the holding member estimated by the estimation unit

According to this configuration, the workpiece is held by the holding member in a position posture falling within a measurable range. When the measurement is executed in this state, the first three-dimensional data including the pieces of three-dimensional data of the holding member and the workpiece is generated by the three-dimensional data generation unit. In addition, the two-dimensional image including the identification member provided on the holding member is acquired by the data acquisition unit. When the position posture of the identification member included in the two-dimensional image is specified by the estimation unit, since the identification member is provided on the holding member, the position posture of the holding member can be estimated based on the position posture of the identification member. When the position posture of the holding member is estimated, it is possible to specify the three-dimensional data of the holding member in the first three-dimensional data. Since the three-dimensional data editing unit removes the three-dimensional data of the holding member from the first three-dimensional data, the three-dimensional data of the holding member can be removed without a user performing a complicated work.

As described above, in a case where the workpiece held by the holding member is measured, since the three-dimensional data of the holding member can be automatically removed, the burden on the user can be reduced.

### BRIEF DESCRIPTION OF THE DRAWINGS

FIG. 1 is a diagram illustrating an overall configuration of a three-dimensional scanner according to an embodiment of the invention;

FIG. 2 is a perspective view of a holding member as viewed from above;

FIG. 3 is a perspective view of the holding member as viewed from below;

FIG. 4 is a plan view of the holding member;

FIG. 5 is a bottom view of the holding member;

FIG. 6 is a front view of the holding member;

FIG. 7 is a rear view of the holding member;

FIG. 8 is a right side view of the holding member;

FIG. 9 is a left side view of the holding member;

FIG. 10 is a plan view illustrating a state where both arms of the holding member are opened;

FIG. 11 is a cross-sectional view taken along line XI-XI in FIG. 4;

FIG. 12 is a cross-sectional view taken along line XII-XII in FIG. 7;

FIG. 13 is a plan view illustrating a state where a release lever of the holding member is at a release position;

FIG. 14 is a diagram corresponding to FIG. 12 illustrating a state where the release lever of the holding member is at the release position;

FIG. 15 is a block diagram of the three-dimensional scanner;

FIG. 16 is a side view of a measurement unit and a pedestal;

FIG. 17 is a block diagram of the measurement unit;

FIG. 18 is a diagram illustrating a configuration example of a module;

FIG. 19 is a flowchart of processing of removing three-dimensional data of the holding member; and

FIG. 20 is a diagram corresponding to FIG. 15 according to a modification of the embodiment.

### DETAILED DESCRIPTION

Hereinafter, an embodiment of the invention will be described in detail with reference to the drawings. Note that, the following description of a preferred embodiment is merely exemplary in nature and is not intended to limit the invention, the application thereof, or the use thereof.

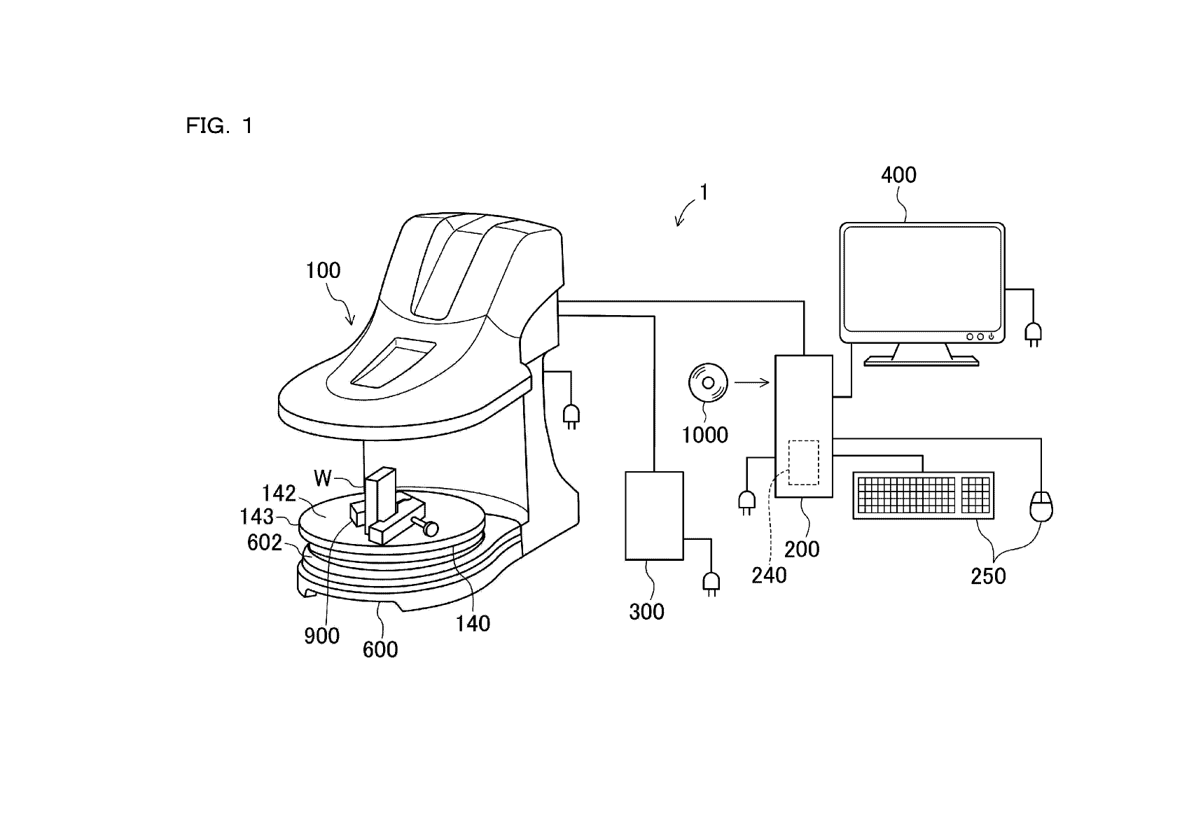

FIG. 1 is a diagram illustrating an overall configuration of a three-dimensional scanner 1 according to the embodiment of the invention. The three-dimensional scanner 1 is a device that irradiates a workpiece (measurement object) W with measurement light and generates three-dimensional data of the workpiece W based on the measurement light reflected by the workpiece W. The three-dimensional scanner 1 can also convert the three-dimensional data of the workpiece W into mesh data and output the mesh data, convert the mesh data of the workpiece W into CAD data and output the CAD data, and convert the mesh data into surface data and output the surface data.

The three-dimensional scanner 1 includes a holding member 900 that holds the workpiece W. Although details will be described later, the workpiece W held by the holding member 900 can be measured. The holding member 900 may be used as necessary, and the workpiece W can be measured without using the holding member 900.

In the following description, when the shape of the workpiece W is measured, in acquiring coordinate information of a front surface of the workpiece W, the workpiece W is irradiated with measurement light of a predetermined pattern, and the coordinate information is acquired by using a signal obtained from reflected light reflected by the front surface of the workpiece W. For example, it is possible to use a measurement method using triangulation using a fringe projection image obtained from the reflected light by projecting the measurement light onto the workpiece W by using structured illumination as the measurement light of the predetermined pattern. However, in the invention, the principle and configuration for acquiring the coordinate information of the workpiece W are not limited thereto, and other methods can also be applied.

The three-dimensional scanner 1 includes a measurement unit 100 that measures the shape of the workpiece W, a pedestal 600 on which the workpiece W can be mounted in a state of being held by the holding member 900, a controller 200, a light source unit 300, and a display unit 400. It is also possible to mount the workpiece W on the pedestal 600 in a state where the workpiece W is not held by the holding member 900. The controller 200 may be incorporated in the measurement unit 100, the light source unit 300 may be incorporated in the measurement unit 100, or the display unit 400 may be incorporated in the measurement unit 100. In addition, the controller 200 and the light source unit 300 may be integrated, or the controller 200 and the display unit 400 may be integrated.

The three-dimensional scanner 1 performs the structured illumination on the workpiece W by the light source unit 300, captures the fringe projection image to generate a depth image having coordinate information, and can measure a three-dimensional dimension and shape of the workpiece W based on the depth image. The measurement using such fringe projection has an advantage that a measurement time can be shortened since three-dimensional measurement can be performed without moving the workpiece W or an optical system such as a lens in a Z direction (height direction).

The pedestal 600 includes a mounting unit 140. The mounting unit 140 includes the rotary stage 143 having a top surface on which the mounting surface 142 on which the workpiece W is mounted is formed. The rotary stage 143 is made of a magnetic material and has magnetization. Examples of the magnetic material include an iron-based metal material, and may be a material having a magnetic force. The invention is not limited to the rotary stage 143, and can also be applied to a non-rotary stage.

Here, a structure of the holding member 900 will be described. As illustrated in FIG. 1, the holding member 900 is an instrument or a device for holding the workpiece W on the rotary stage 143, and can also be referred to as, for example, a workpiece holding tool, a workpiece holding device, or the like. In a case where the workpiece W has a thin plate shape, it may be difficult to stand and mount the workpiece W on the rotary stage 143. In such a case, the plate-shaped workpiece W can be stabilized by being mounted on the rotary stage 143 in a lying posture, and when the workpiece is mounted in such a manner, scanning is performed in two postures of a posture in which a front side of the workpiece W is positioned on an upper side and a posture in which the front side of the workpiece W is positioned on a lower side in order to scan the entire workpiece W.

However, when the plate-shaped workpiece W is laid down on the stage, a dimension of a side surface of the workpiece W in an upper-lower direction corresponds to a thickness dimension of the workpiece W and becomes short. When the dimension of the side surface of the workpiece W in the upper-lower direction becomes short, since an overlap region between the two postures is narrowed, there is a possibility that accuracy is lowered when pieces of three-dimensional data measured in the two postures are combined.

In addition, in addition to the viewpoint of accuracy, it is originally important to select an appropriate scanning posture in order to scan the workpiece W from all directions with a smaller number of times. However, in a case where it is desired to select an arrangement posture having a small area in contact with the rotary stage 143, there may be a case where it is difficult to execute the measurement of the workpiece W in the arrangement posture.

In the present embodiment, the holding member 900 can be used to stably hold the workpiece W on the rotary stage 143 even in the case of the plate-shaped workpiece W that is unstable to be mounted in an upright posture or an arrangement posture in which the contact area of the workpiece W with the rotary stage 143 is small. “Stably holding” means not only that the workpiece W is less likely to fall during scanning, but means that the workpiece W is less likely to vibrate and does not undergo minute displacement.

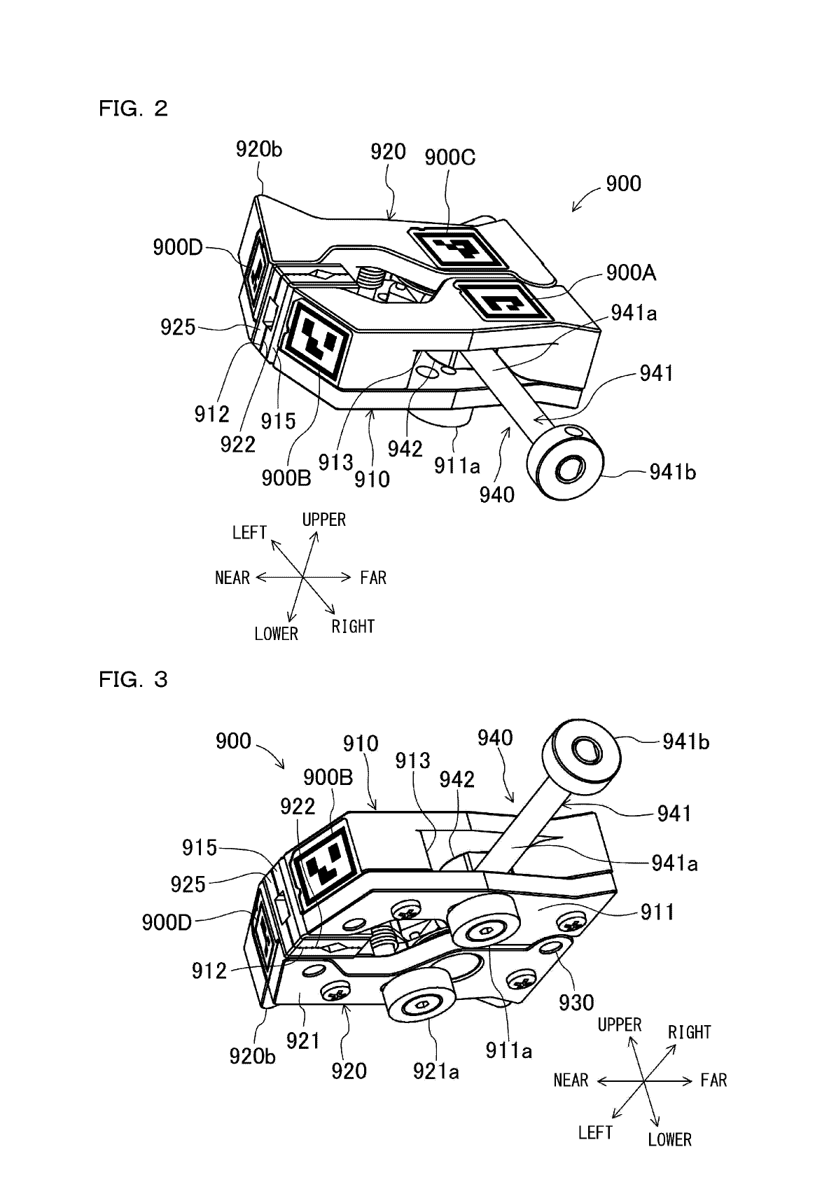

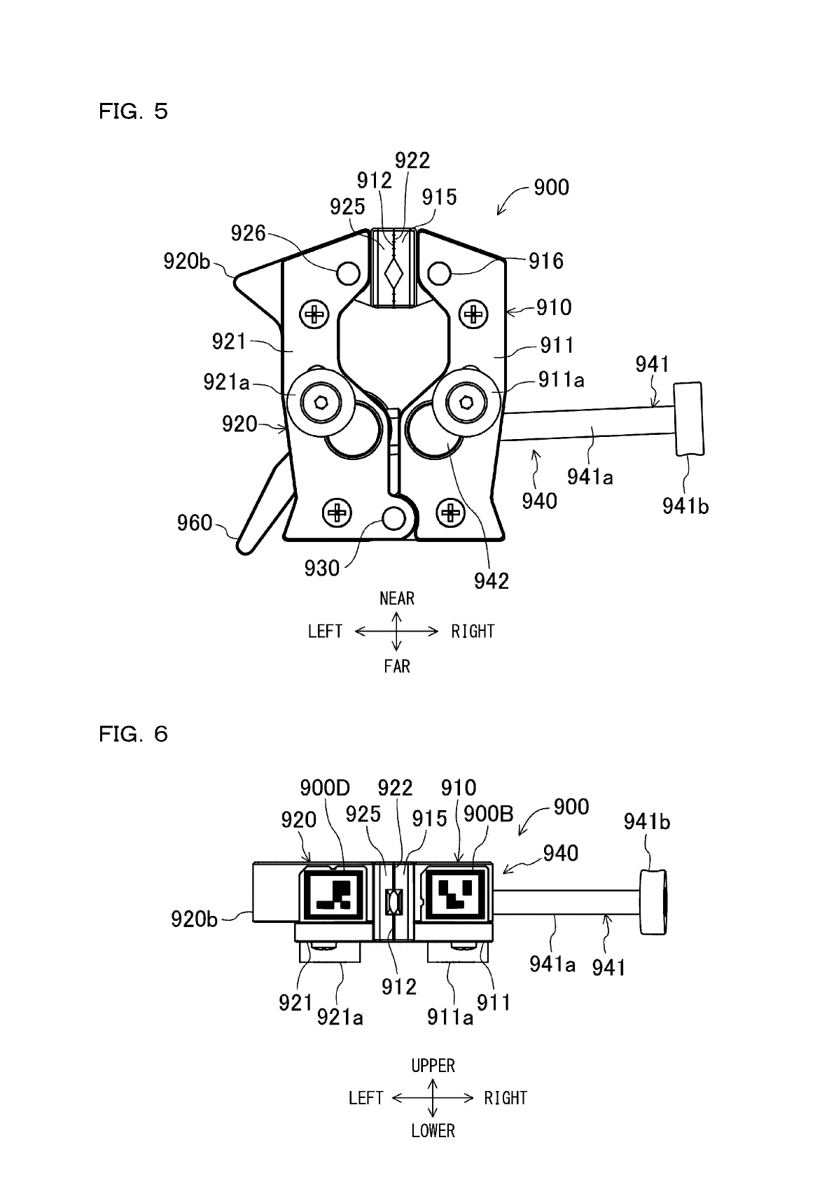

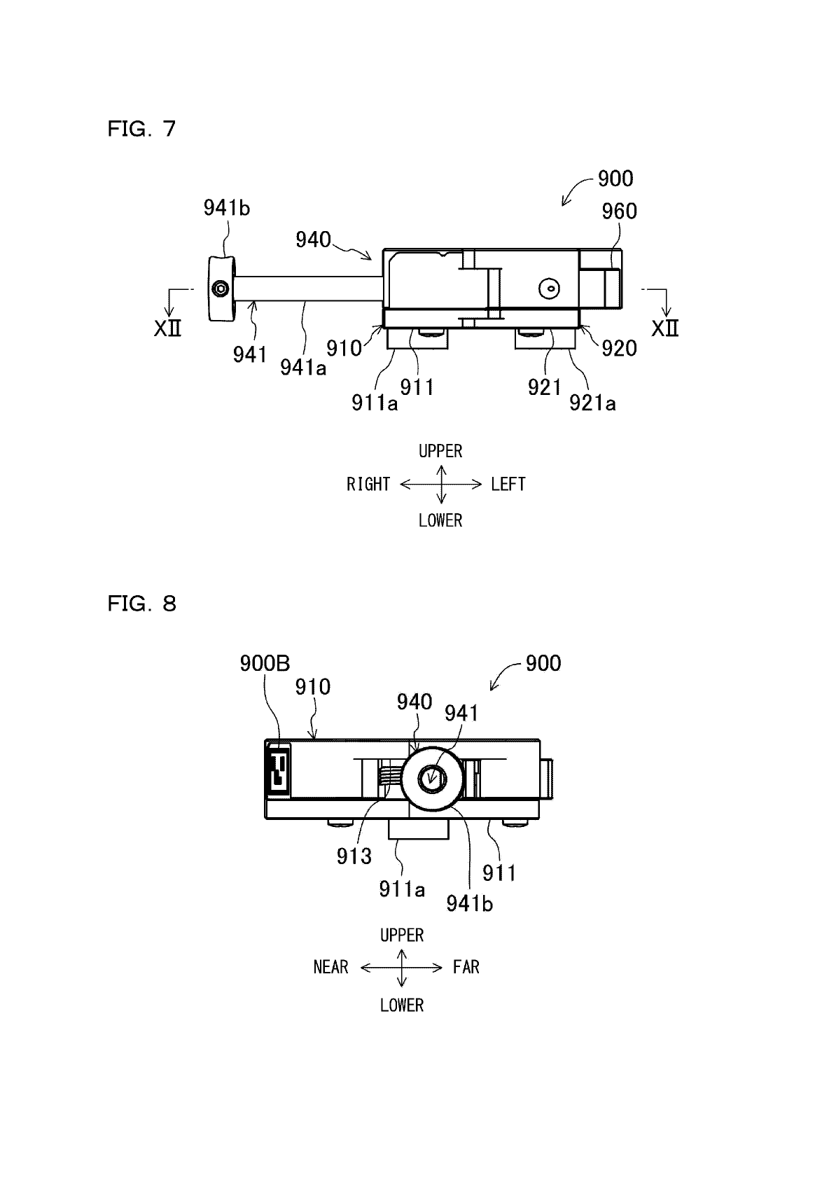

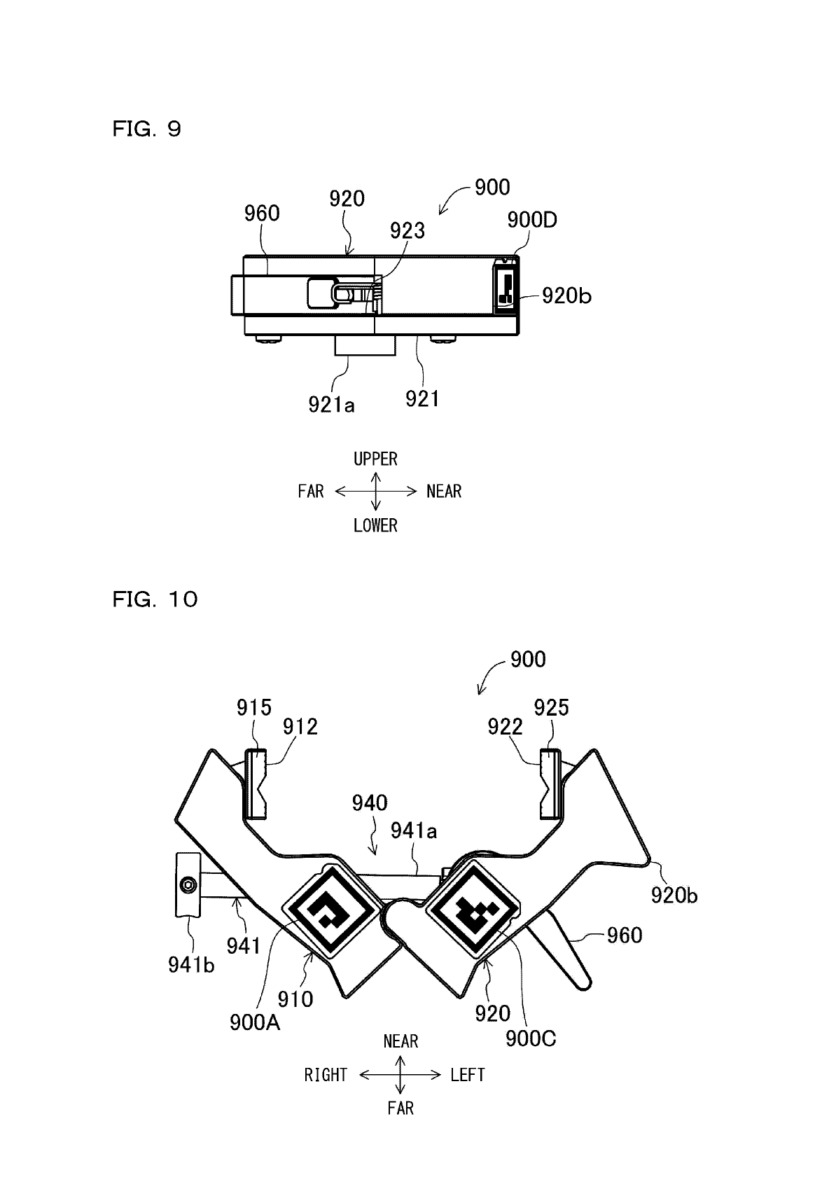

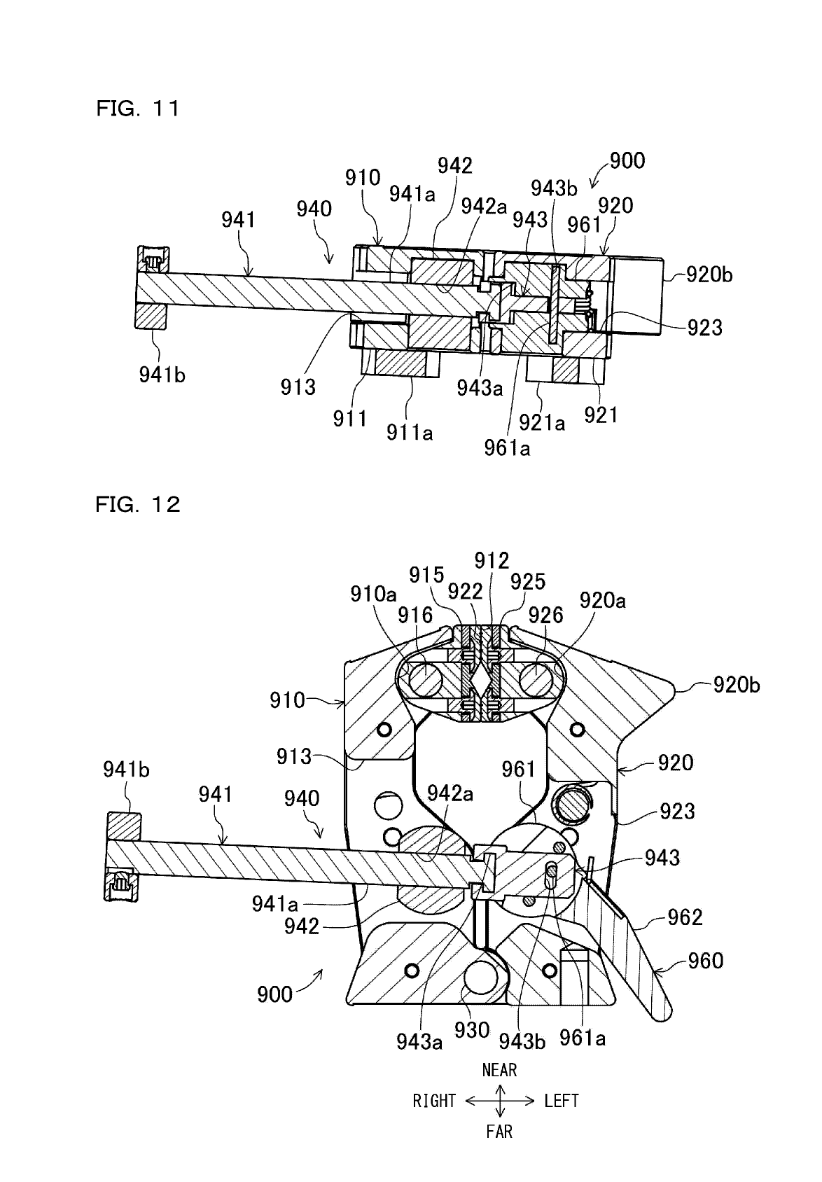

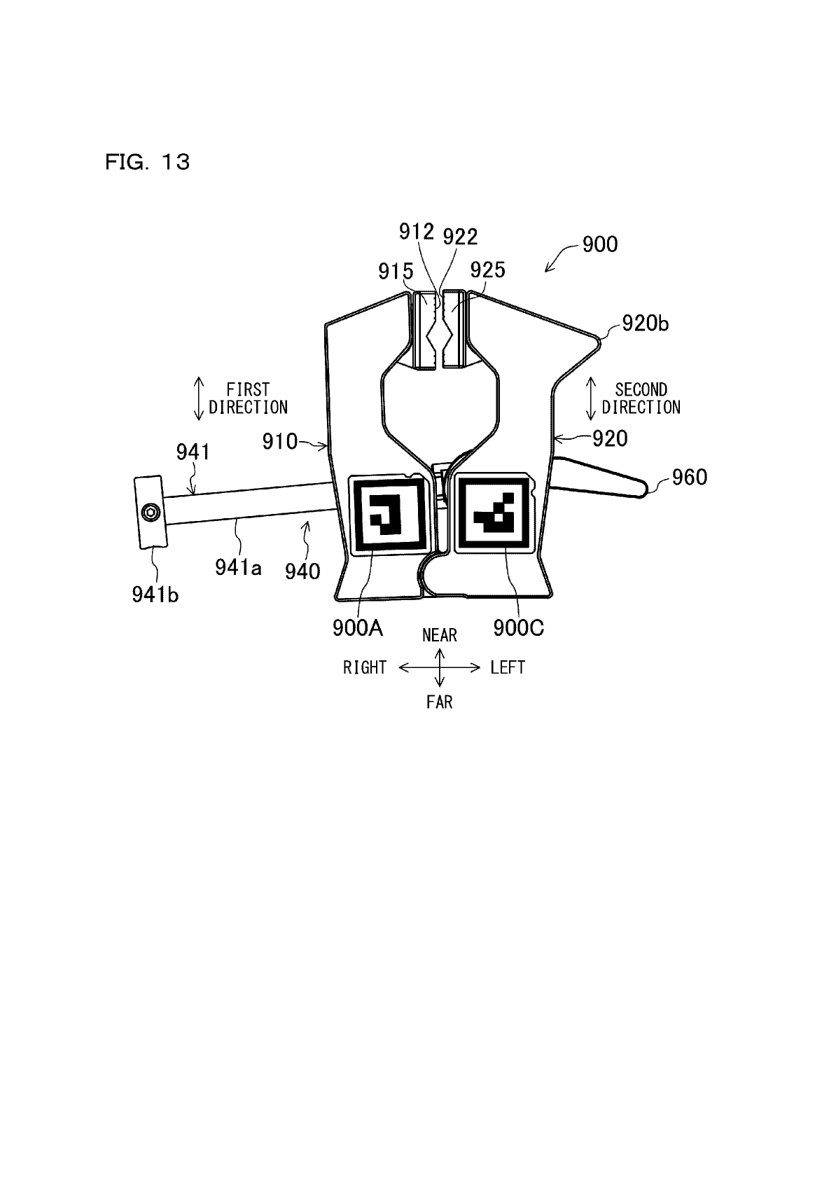

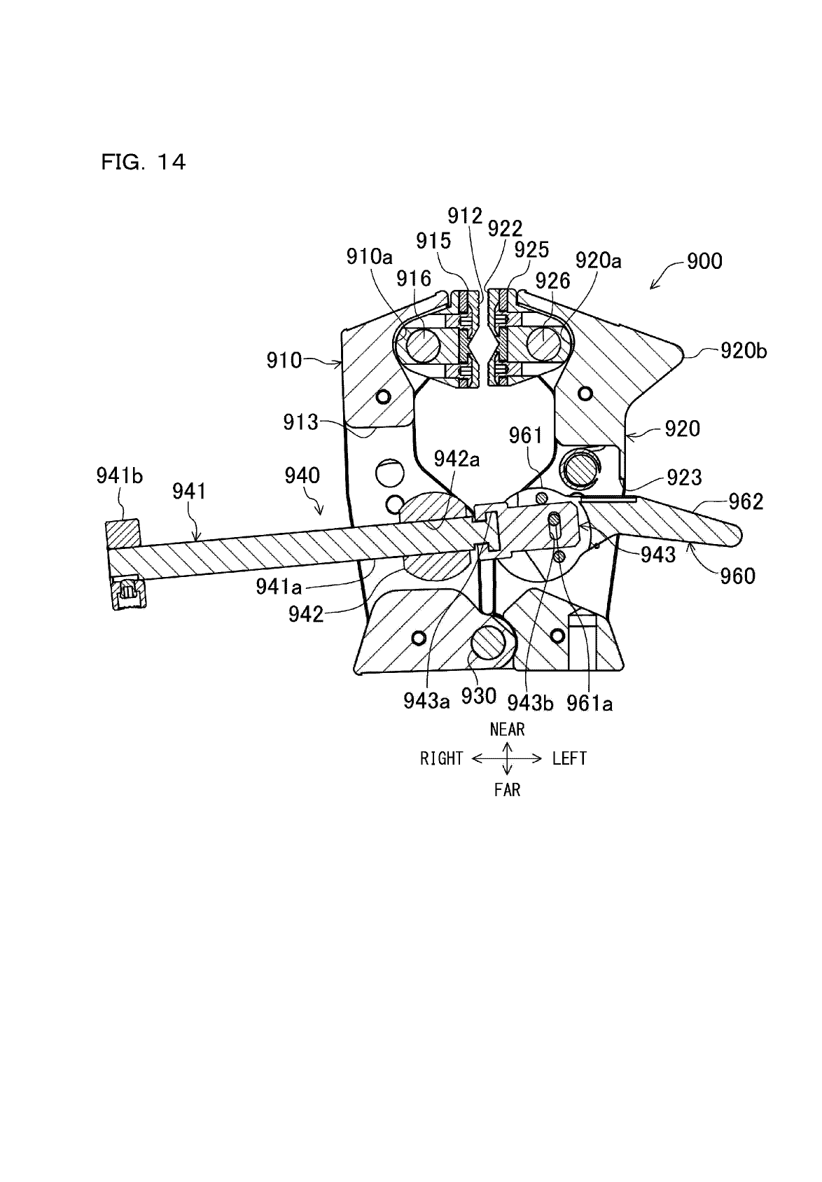

As illustrated in FIGS. 2, 3, and the like, the holding member 900 includes a first arm (first member) 910 and a second arm (second member) 920 that sandwich the workpiece W, and an opening and closing hinge 930 that connects the first arm 910 and the second arm 920 to be openable and closable. FIGS. 2 to 9, 11, and 12 illustrate a state where the first arm 910 and the second arm 920 are fully closed. FIG. 10 illustrates a state where the first arm 910 and the second arm 920 are widely opened. FIGS. 13 and 14 illustrate a state where the first arm 910 and the second arm 920 are slightly opened. As described, the first arm 910 and the second arm 920 are switched from the closed state to the opened state and from the opened state to the closed state, and a degree of opening can be set according to the shape and size of the workpiece W.

In the description of this embodiment, a direction of the holding member 900 is defined as illustrated in each drawing. That is, a far side of the holding member 900 is a side connected by the opening and closing hinge 930, and a near side of the holding member 900 is a side on which the first arm 910 and the second arm 920 are opened. The near side may be defined as a front side, and the far side may be defined as a back side. In addition, a right side of the holding member 900 is a side positioned on the right when the holding member 900 is viewed from the near side, and a left side of the holding member 900 is a side positioned on the left when the holding member 900 is viewed from the near side. A left-right direction may be defined as a width direction. Further, a side on which the holding member 900 is positioned when being used on the rotary stage 143 is defined as an upper side, and a side on which the holding member 900 is positioned when being used on the rotary stage 143 is defined as a lower side. The upper-lower direction may be defined as a thickness direction. The definition of this direction is for the sake of convenience in description of the embodiment, and does not limit the posture at the time of use.

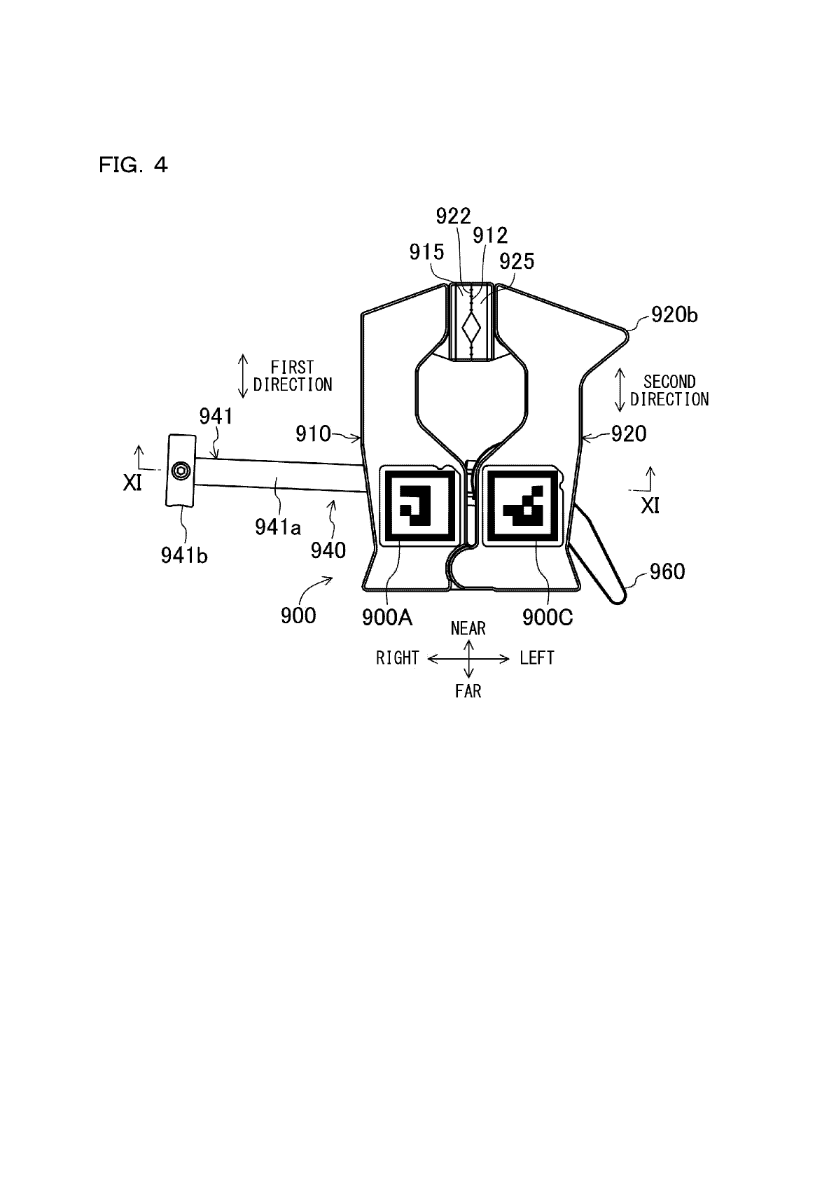

Since the first arm 910 and the second arm 920 are positioned on the right side and the left side of the holding member 900, these arms may be referred to as a right arm and a left arm, respectively. In the plan view illustrated in FIG. 4, a depth direction in the fully closed state is defined as a longitudinal direction of the first arm 910. The first arm 910 has an outer shape that is long in the depth direction. In the fully closed state, a longitudinal direction of the second arm 920 is substantially parallel to the longitudinal direction of the first arm 910. Accordingly, the second arm 920 also has an outer shape that is long in the depth direction. In this embodiment, a first direction that is the longitudinal direction of the first arm 910 and a second direction that is the longitudinal direction of the second arm 920 are substantially parallel, but the first direction and the second direction may intersect in plan view.

As illustrated in FIGS. 2 and 3, the first arm 910 has a plurality of side surfaces including an upper surface, a lower surface, and both left and right side surfaces. The lower surface of the first arm 910 is a first mounting surface 911 that is long in the depth direction. A first magnetic member 911a which is not an essential member of the invention is provided on the first mounting surface 911. A left side surface of the first arm 910 includes a first workpiece holding surface 912.

The first magnetic member 911a is made of a permanent magnet that generates a magnetic force that can be attracted to the rotary stage 143 made of a magnetic material. In a case where the rotary stage 143 is made of the permanent magnet, the first magnetic member 911a may be made of a magnetic material such as iron, or may be made of a permanent magnet. The first magnetic member 911a may be made of a combination of a magnetic material such as iron and a permanent magnet.

The first magnetic member 911a is positioned at an intermediate portion of the first arm 910 in the longitudinal direction. A fixing structure of the first magnetic member 911a to the first arm 910 is not particularly limited, but examples thereof include a fixing structure using a screw or the like. In addition, in the present embodiment, only one first magnetic member 911a is provided, but the invention is not limited thereto, and a plurality of first magnetic members 911a may be provided. In a case where the plurality of first magnetic members 911a are provided, these magnetic members can be provided at intervals in the longitudinal direction of the first arm 910.

A lower end surface of the first magnetic member 911a is a flat surface. Since the mounting surface 142 of the rotary stage 143 also has a portion having a flat surface, the first magnetic member 911a is less likely to wobble and be stable with respect to the rotary stage 143 in a state of being attracted to the rotary stage 143. The first magnetic member 911a may be embedded in the first arm 910. An attraction force of the first magnetic member 911a to the rotary stage 143 can be voluntarily set according to a type, a size, and the like of the permanent magnet to be used. In a case where the rotary stage 143 is made of the permanent magnet, an attraction force can be set according to the type of the permanent magnet forming the rotary stage 143. In this embodiment, in a state where a general workpiece W is held by the holding member 900, the attraction force of the first magnetic member 911a and the attraction force of the rotary stage 143 are set such that the first arm 910 can be firmly attracted to the rotary stage 143 such that the workpiece W does not fall or swing.

In addition, the first magnetic member 911a may constitute a first attraction portion. In this case, the first arm 910 includes the first attraction portion. The first attraction portion is a portion that applies an attraction force for holding the first mounting surface 911 to come into contact with the mounting surface (predetermined surface) 142 of the rotary stage 143. The first attraction portion may include a part of the first arm 910. That is, in a case where a part of the first arm 910 is made of the permanent magnet, the first arm 910 is a member having the first attraction portion.

The second arm 920 has a plurality of side surfaces including an upper surface, a lower surface, and both left and right side surfaces. The lower surface of the second arm 920 is a second mounting surface 921 that is long in the depth direction. A second magnetic member 921a which is not an essential member of the invention and is made of, for example, a permanent magnet or the like is provided on the second mounting surface 921. A right side surface of the second arm 920 includes a second workpiece holding surface 922.

Similarly to the first magnetic member 911a, the second magnetic member 921a is made of a permanent magnet that generates a magnetic force capable of being attracted to the rotary stage 143. In a case where the rotary stage 143 is made of the permanent magnet, the second magnetic member 921a may be made of a magnetic material such as iron, or may be made of a permanent magnet. The second magnetic member 921a may be made of a combination of a magnetic material such as iron and a permanent magnet.

The second magnetic member 921a is positioned at an intermediate portion of the second arm 920 in the longitudinal direction. A fixing structure of the second magnetic member 921a to the second arm 920 is not particularly limited, but examples thereof include a fixing structure using a screw or the like. In addition, in the present embodiment, only one second magnetic member 921a is provided, but the invention is not limited thereto, and a plurality of second magnetic members 921a may be provided. In a case where the plurality of second magnetic members 921a are provided, these second magnetic members can be provided at intervals in the longitudinal direction of the second arm 920.

A lower end surface of the second magnetic member 921a is a flat surface. Since the mounting surface 142 of the rotary stage 143 also has a portion having a flat surface, the second magnetic member 921a is less likely to wobble and be stable with respect to the rotary stage 143 in a state of being attracted to the rotary stage 143. In particular, since the first magnetic member 911a is provided in the first arm 910 and the second magnetic member 921a is provided in the second arm 920, when the holding member 900 is mounted on the rotary stage 143, at least two parts separated from each other are attracted to the rotary stage 143. As a result, the holding member 900 holding the workpiece W is further stabilized.

The second magnetic member 921a may be embedded in the second arm 920. An attraction force of the second magnetic member 921a to the rotary stage 143 can be voluntarily set according to a type, a size, and the like of the permanent magnet to be used. In this embodiment, in a state where a general workpiece W is held by the holding member 900, the attraction force of the second magnetic member 921a is set such that the second arm 920 can be firmly attracted to the rotary stage 143 such that the workpiece W does not fall or swing.

In addition, the second magnetic member 921a may constitute a second attraction portion. In this case, the second arm 920 includes the second attraction portion. The second attraction portion is a portion that applies an attraction force for holding the second mounting surface 921 to come into contact with the mounting surface (predetermined surface) 142 of the rotary stage 143. The second attraction portion may include a part of the second arm 920. That is, in a case where a part of the second arm 920 is made of the permanent magnet, the second arm 920 is a member having the second attraction portion.

Since the holding member 900 includes the first magnetic member 911a and the second magnetic member 921a, as illustrated in FIG. 1, the workpiece W can be held on the rotary stage 143 in a predetermined position posture in a state where the holding member 900 is attracted to the rotary stage 143. Although not illustrated, only one of the first magnetic member 911a and the second magnetic member 921a may be provided. In addition, only one of the first attraction portion and the second attraction portion may be provided.

As illustrated in FIG. 12 and the like, the opening and closing hinge 930 includes a rotation shaft extending in the upper-lower direction. The opening and closing hinge 930 is provided at an end portion (one end portion in the first direction) on the far side of the holding member 900, and an end portion on a far side of the first arm 910 and an end portion on a far side of the second arm 920 are connected by the opening and closing hinge 930. The opening and closing hinge 930 serves as a rotation shaft when a relative positional relationship between the first arm 910 and the second arm 920 is adjusted by an adjustment mechanism 940 to be described later.

A first holding portion 915 is provided at an end portion on a near side of the first arm 910. That is, a first recess portion 910a opened to the second arm 920 side is formed at the end portion on the near side of the first arm 910. A base portion of the first holding portion 915 is accommodated in the first recess portion 910a. In the first arm 910, a first spindle 916 that rotatably supports the base portion of the first holding portion 915 is provided in the first recess portion 910a. The first spindle 916 extends in the upper-lower direction, and the first holding portion 915 rotates about the first spindle 916. The first workpiece holding surface 912 is formed on an end surface of the first holding portion 915. The first workpiece holding surface 912 faces leftward, but an orientation can be changed by rotating the first holding portion 915 about the first spindle 916. For example, even in a state where the first arm 910 and the second arm 920 are opened as illustrated in FIG. 10, the first workpiece holding surface 912 can be kept directed to the left by rotating the first holding portion 915 about the first spindle 916. In addition, the first holding portion 915 is rotated about the first spindle 916 in accordance with the shape, size, and the like of the workpiece W, and thus, the first workpiece holding surface 912 can be stably applied to the front surface of the workpiece W in a range as wide as possible.

Similarly to the first arm 910, a second holding portion 925 is also provided at an end portion on a near side of the second arm 920. That is, a second recess portion 920a opened to the first arm 910 side is formed at the end portion on the near side of the second arm 920. A base portion of the second holding portion 925 is accommodated in the second recess portion 920a. In the second arm 920, a second spindle 926 that rotatably supports the base portion of the second holding portion 925 is provided in the second recess portion 920a. The second spindle 926 extends in the upper-lower direction, and the second holding portion 925 rotates about the second spindle 926. A second workpiece holding surface 922 is formed on an end surface of the second holding portion 925. Similarly to the first workpiece holding surface 912, the second workpiece holding surface 922 faces rightward, but an orientation can be changed by rotating the second holding portion 925 about the second spindle 926.

As illustrated in FIG. 12, a first through-hole 913 penetrating in a direction (left-right direction) in which the first arm 910 comes into contact with and separates from the second arm 920 is formed in the intermediate portion of the first arm in the longitudinal direction. The first through-hole 913 is opened to the left side surface of the first arm 910 and is opened to a right side surface.

A second through-hole 923 penetrating in a direction (left-right direction) in which the second arm 920 comes into contact with and separates from the first arm 910 is formed in the intermediate portion of the second arm in the longitudinal direction. The second through-hole 923 is opened to a left side surface of the second arm 920 and is opened to the right side surface.

The holding member 900 includes an adjustment mechanism 940 that adjusts the relative positional relationship between the first arm 910 and the second arm 920. The adjustment mechanism 940 is a mechanism that defines a positional relationship between the first arm 910 and the second arm 920 such that the first workpiece holding surface 912 and the second workpiece holding surface 922 face each other in a state where the first mounting surface 911 of the first arm 910 and the second mounting surface 921 of the second arm 920 face the same lower direction, and relatively moves the first arm 910 and the second arm 920 in a direction in which the first workpiece holding surface 912 and the second workpiece holding surface 922 come into contact with and separate from each other.

Specifically, the adjustment mechanism 940 includes a rotary bolt 941, a bearing nut 942 provided on the first arm 910, and a distal end holding portion 943 provided on the second arm 920. The bearing nut 942 is rotatably supported about an axis extending in the upper-lower direction with respect to the first arm 910 in a state of being accommodated in the first through-hole 913 of the first arm 910. That is, the bearing nut 942 is supported to the first arm 910 so as to be rotatable about an axis in a direction orthogonal to an axial direction of the rotary bolt 941.

A screw hole 942a penetrating in the left-right direction (direction orthogonal to the axial direction during rotation) is formed in the bearing nut 942. A screw shaft portion 941a of the rotary bolt 941 is screwed into the screw hole 942a of the bearing nut 942 in a state of being in a posture extending in the left-right direction, and penetrates the bearing nut 942.

The distal end holding portion 943 is accommodated inside the second through-hole 923 of the second arm 920. A fitting hole 943a opened toward a right side is formed in a right side portion of the distal end holding portion 943. A distal end portion of the screw shaft portion 941a is fitted into the fitting hole 943a, and the distal end holding portion 943 holds a distal end portion of the rotary bolt 941 by fitting the distal end portion of the screw shaft portion 941a into the fitting hole 943a. The fitting hole 943a is formed so as to allow the rotation of the screw shaft portion 941a with respect to the distal end holding portion 943 while preventing the relative movement in the left-right direction with respect to the distal end holding portion 943 in a state where the distal end portion of the screw shaft portion 941a is fitted to prevent the screw shaft portion 941a from coming off. As will be described later, the distal end holding portion 943 is supported by the second arm 920 via a release lever 960.

A knob 941b for operation is provided at a proximal end portion of the rotary bolt 941. A user can rotate the rotary bolt 941 by holding the knob 941b, and a relative positional relationship between the rotary bolt 941 and the bearing nut 942 can be changed by rotating the rotary bolt 941, and the relative positional relationship between the first holding portion 915 and the second holding portion 925 can be adjusted.

When the rotary bolt 941 is rotated in a direction in which the rotary bolt 941 moves a left direction with respect to the bearing nut 942, the first arm 910 and the second arm 920 can be opened as illustrated in FIG. 10. Conversely, when the rotary bolt 941 is rotated in a direction in which the rotary bolt 941 moves to a right direction with respect to the bearing nut 942, the first arm 910 and the second arm 920 can be closed until the first workpiece holding surface 912 and the second workpiece holding surface 922 come into contact with each other as illustrated in FIG. 4 and the like. As described, the rotary bolt 941 is rotated, and thus, an opening angle between the first arm 910 and the second arm 920 can be changed substantially steplessly.

After the first arm 910 and the second arm 920 are opened, the workpiece W is arranged between the first workpiece holding surface 912 and the second workpiece holding surface 922, and then the rotary bolt 941 is rotated in a direction in which the first arm 910 and the second arm 920 are closed. As a result, the first workpiece holding surface 912 and the second workpiece holding surface 922 can be brought into contact with the front surface of the workpiece W. The rotary bolt 941 is tightened, and thus, the workpiece W can be sandwiched between the first workpiece holding surface 912 and the second workpiece holding surface 922.

In the present embodiment, the release lever 960 is used, and thus, the workpiece W can be easily switched to a switched state where the workpiece W is sandwiched with a stronger force, and can be easily switched from the switched state to a non-switched state. Specifically, as illustrated in FIG. 4 and the like, the holding member 900 is swingably supported with respect to the second arm 920, and includes the release lever 960 for changing a relative position between the first workpiece holding surface 912 and the second workpiece holding surface 922 by the swing. As illustrated in FIG. 12, the release lever 960 includes a proximal end portion 961 accommodated in the second through-hole 923 of the second arm 920, and an operation portion 962 extending leftward from the proximal end portion 961. The operation portion 962 is provided so as to protrude from the left side surface of the second arm 920 (one side surface positioned opposite to the second workpiece holding surface 922).

The proximal end portion 961 is rotatably supported about an axis extending in the upper-lower direction with respect to the second arm 920 inside the second through-hole 923. A pin portion 961a extending in the upper-lower direction is provided in the proximal end portion 961. The pin portion 961a is inserted into a holding hole 943b formed in a left side portion of the distal end holding portion 943. Accordingly, the left side portion of the distal end holding portion 943 is connected to the proximal end portion 961 of the release lever 960 via the pin portion 961a.

The holding hole 943b is a long hole that is long in the depth direction of the holding member 900. As illustrated in FIG. 12, when the release lever 960 is swung toward the far side to be at a locked position, the distal end holding portion 943 connected to the release lever 960 by the pin portion 961a is displaced toward a left side. As a result, since the rotary bolt 941 is pulled to a left side, a force can be applied in the direction in which the first arm 910 and the second arm 920 are closed. At this time, when the workpiece W is arranged so as to come into contact with the first workpiece holding surface 912 and the second workpiece holding surface 922, the holding member 900 is in a sandwiched state of sandwiching the workpiece W with a strong force.

On the other hand, as illustrated in FIG. 14, when the release lever 960 is swung toward the near side to be at an unlocked position, the distal end holding portion 943 is displaced to a right side. As a result, since the rotary bolt 941 is pushed to a right side, a force is applied in a direction in which the first arm 910 and the second arm 920 are opened. As a result, the holding member 900 is switched from the sandwiched state to the non-sandwiched state. That is, the release lever 960 is merely swung, and thus, the holding member 900 can be switched from the sandwiched state to the non-sandwiched state, and from the non-sandwiched state to the sandwiched state. An operation of the release lever 960 may be performed as necessary, and in the case of the workpiece W that can be held without swinging the release lever 960, the operation of the release lever 960 can be omitted.

A protrusion portion 920b is provided on the left side surface of the second arm 920. The protrusion portion 920b is positioned at a portion separated from the operation portion 962 of the release lever 960 toward the near side of the holding member 900, and the protrusion portion 920b and the operation portion 962 are arranged at a predetermined interval in the depth direction. The protrusion portion 920b can be used as a portion on which the user hooks a finger when the release lever 960 is swung toward the near side. For example, the thumb is hooked on the operation portion 962 of the release lever 960 in a state where the index finger or the like is hooked on the protrusion portion 920b, and thus, it is easy to apply a force when an operation of swinging the release lever 960 toward the near side is performed.

The attraction portion of the present embodiment is made of a permanent magnet, but the invention is not limited thereto, and the attraction portion may be made of, for example, an adhesive, an adhesive, or the like. In addition, a height adjustment member may be detachably attached to the first magnetic member 911a and the second magnetic member 921a. The height adjustment member is a member having a predetermined dimension in the upper-lower direction. An upper surface of the height adjustment member is attracted to, for example, the first magnetic member 911a, while a lower surface of the height adjustment member is attracted to, for example, the rotary stage 143. In addition, as described above, the holding member 900 can be attracted to the rotary stage 143 in a posture in which opening and closing directions of the first arm 910 and the second arm 920 are a horizontal direction, can be attracted to the rotary stage 143 in a posture in which the opening and closing directions of the first arm 910 and the second arm 920 are a vertical direction, or can be attracted to the rotary stage 143 in a posture in which the opening and closing directions of the first arm 910 and the second arm 920 are tilted with respect to a horizontal plane, and the posture of the holding member 900 at the time of use is not particularly limited.

At the time of use of the holding member 900, the workpiece W is sandwiched between the first holding portion 915 provided on the first arm 910 and the second holding portion 925 provided on the second arm 920 and held on the rotary stage 143. At this time, before the workpiece W is held by the holding member 900, the holding member 900 is mounted on the rotary stage 143. Then, the first magnetic member 911a and the second magnetic member 921a are attracted to the rotary stage 143. When the relative positional relationship between the first arm 910 and the second arm 920 is adjusted by the adjustment mechanism 940 in the attracted state, a state of being attracted to the rotary stage 143 by the first magnetic member 911a and the second magnetic member 921a is maintained, and the rotary bolt 941 is rotated. As a result, the first arm 910 and the second arm 920 slide with respect to the rotary stage 143 with the opening and closing hinge 930 as the rotation axis. That is, when the opening angle between the first arm 910 and the second arm 920 is changed by the adjustment mechanism 940, the attraction forces of the first magnetic member 911a and the second magnetic member 921a are set such that the first magnetic member 911a is allowed to slide with respect to the rotary stage 143 and the second magnetic member 921a is allowed to slide with respect to the rotary stage 143. When the position is adjusted by the adjustment mechanism 940, the release lever 960 is kept at the unlocked position.

After the positional relationship between the first arm 910 and the second arm 920 is adjusted by the adjustment mechanism 940 and the workpiece W is sandwiched between the first holding portion 915 and the second holding portion 925, the release lever 960 is set to the locked position. Thus, for example, even a thin workpiece W or an elongated workpiece W can be stabilized in a standing posture on the rotary stage 143.

The first arm 910 and the second arm 920 may be connected to a guide rail. In this case, the first arm 910 and the second member 920 can be relatively moved along the guide rail by rotating the rotary bolt 941.

Identification members 900A, 900B, 900C, and 900D for specifying the position posture of the holding member 900 are provided on the holding member 900. The identification members 900A, 900B, 900C, and 900D are, for example, augmented reality (AR) markers, but may be codes such as two-dimensional codes instead of the AR markers. In addition, as the identification members 900A, 900B, 900C, and 900D, codes such as two-dimensional codes may be provided in addition to the AR markers. Although all the identification members 900A, 900B, 900C, and 900D may be the same, in the present embodiment, all the identification members 900A, 900B, 900C, and 900D are different. As a result, it is possible to discriminate which part of the holding member 900 the identification member is provided, and it is possible to specify the part of the holding member 900 by specifying the identification member.

The identification members 900A, 900B, 900C, and 900D include first identification members 900A and 900B provided on the first arm 910 and second identification members 900C and 900D provided on the second arm 920. The identification members 900A, 900B, 900C, and 900D may be provided by being attached to the first arm 910 and the second arm 920, or may be provided by being printed or engraved. In addition, the identification member may be provided only on the first arm 910, or the identification member may be provided only on the second arm 920. In the following description, an example in which the identification members 900A, 900B, 900C, and 900D are provided on the first arm 910 and the second arm 920 will be described.

The first identification members 900A and 900B include a first identification member 900A on the far side provided on a far side portion of the upper surface of the first arm 910 and a first identification member 900B on the near side provided on an end surface on the near side of the first arm 910. As described above, the two first identification members 900A and 900B are provided on the first arm 910 at an interval. In addition, since the two first identification members 900A and 900B are provided on different surfaces of the first arm 910, directions in which the two first identification members 900A and 900B face are different. The surfaces on which the first identification members 900A and 900B are provided may be any surfaces of the first arm 910 except the first mounting surface 911, and are not particularly limited. In addition, the number of first identification members 900A and 900B is not limited to two, and may be one or three or more. In addition, the plurality of first identification members 900A and 900B may be provided on the same surface of the first arm 910.

The second identification members 900C and 900D include a second identification member 900C on the far side provided on the far side portion of the upper surface of the second arm 920 and a second identification member 900D on the near side provided on an end surface on the near side of the second arm 920. Similarly to the first arm 910, two second identification members 900C and 900D are provided on the second arm 920 at an interval, and are provided on different surfaces of the second arm 920. The surfaces on which the second identification members 900C and 900D are provided may be any surfaces of the second arm 920 except the second mounting surface 921, and are not particularly limited. In addition, the number of second identification members 900C and 900D is not limited to two, and may be one or three or more. In addition, the plurality of second identification members 900C and 900D may be provided on the same surface of the second arm 920.

The identification members 900A, 900B, 900C, and 900D include IDs for specifying the identification members 900A, 900B, 900C, and 900D, respectively. That is, the identification member 900A includes unique identification information (ID), and it is possible to specify the identification member 900A based on the identification information. The other identification members 900B, 900C, and 900D also include unique identification information, and can be identified as the identification members 900B, 900C, and 900D based on the identification information.

The controller 200 illustrated in FIG. 1 includes a storage device (storage unit) 240. The storage device 240 includes, for example, a solid state drive, a hard disk drive, or the like. The storage device 240 is a portion that stores data in which the IDs of the identification members 900A, 900B, 900C, and 900D, positions of the identification members 900A, 900B, 900C, and 900D on the holding member 900, and the shape of the holding member 900 are associated with each other. The storage device 240 stores the shape of the holding member 900 in which a distance between the first workpiece holding surface 912 and the second workpiece holding surface 922 is in a predetermined state. The predetermined state may be any of a state where the arms 910 and 920 are fully closed as illustrated in FIG. 4, a state where the arms 910 and 920 are fully opened as illustrated in FIG. 10, and a state where the arms 910 and 920 are at any degrees of opening as illustrated in FIG. 13.

For example, the ID of the identification member 900A, the position of the identification member 900A on the holding member 900, and three-dimensional shape data of the holding member 900 on which the identification member 900A is provided can be stored in the storage device 240 in association with each other. Similarly, the other identification members 900B, 900C, and 900D can be stored in the storage device 240 in association with the ID, the positions of the identification members 900B, 900C, and 900D on the holding member 900, and the shape of the holding member 900. As a result, for example, when the ID of the identification member 900A is specified, the position of the identification member 900A on the holding member 900 and the three-dimensional shape data of the holding member 900 on which the identification member 900A is provided can be read from the storage device 240. A format of the three-dimensional shape data may be any format.

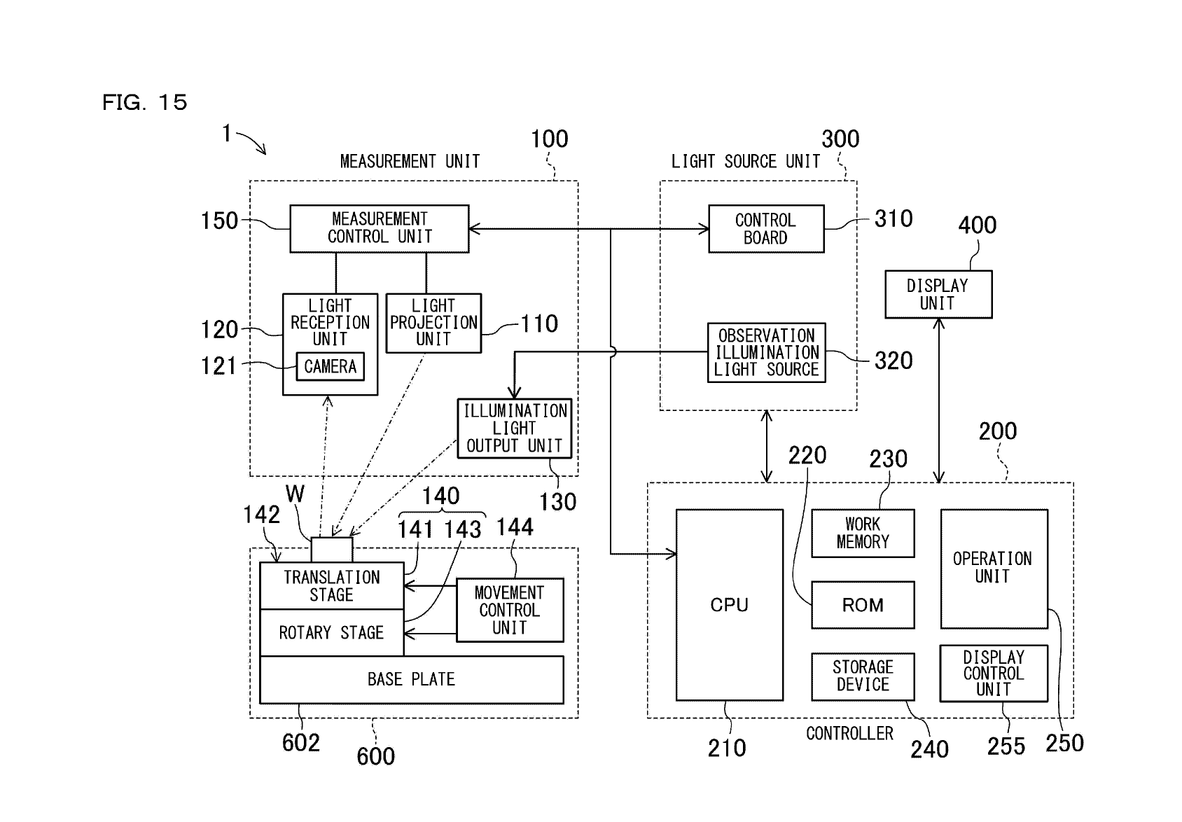

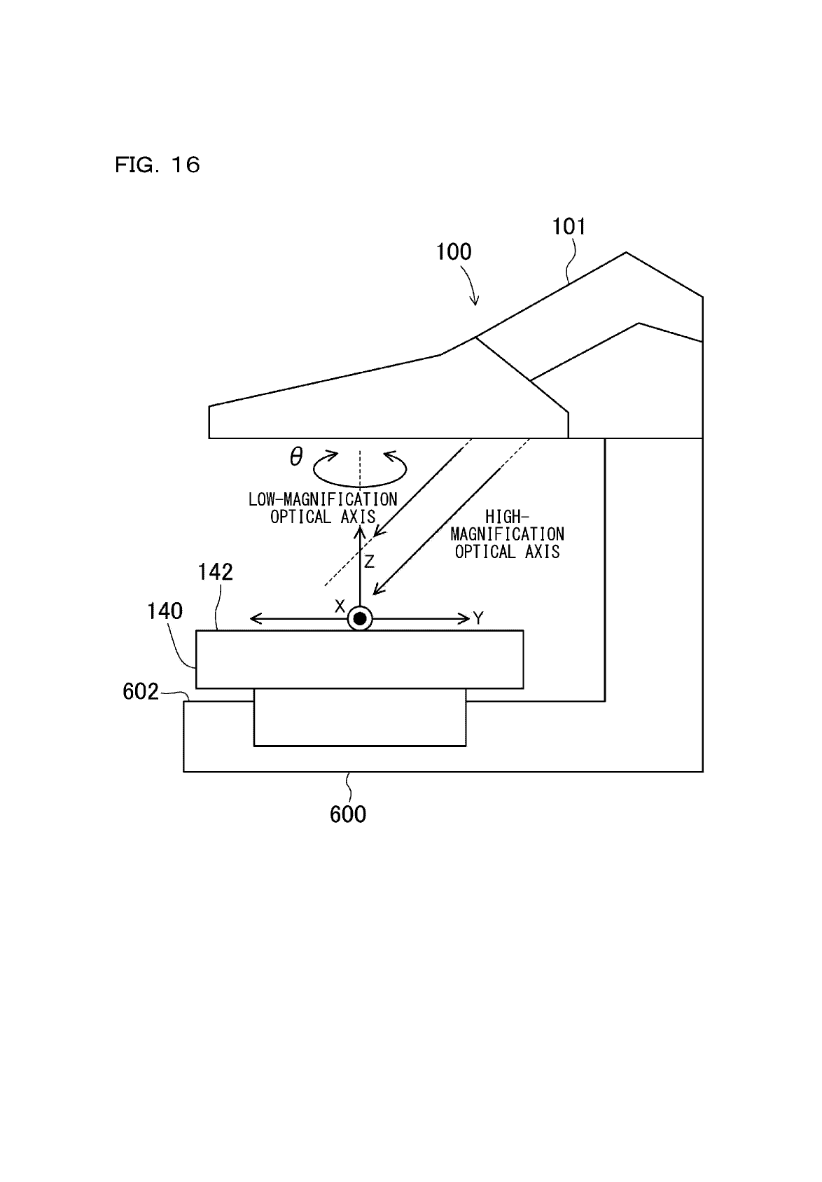

FIG. 15 illustrates a block diagram of the three-dimensional scanner 1. As illustrated in FIG. 15, the measurement unit 100 includes a pattern light projection unit (first light projection unit) 110 that projects pattern light for measurement onto the workpiece W, a light reception unit 120, a measurement control unit 150, and an illumination light output unit 130. The light projection unit 110 is a portion that irradiates the workpiece W mounted on a mounting unit 140 to be described later with the measurement light of the predetermined pattern. In a case where the holding member 900 is used, the light projection unit 110 also irradiates the holding member 900 with the measurement light. The mounting of the workpiece W on the mounting unit 140 is the same as the arrangement of the workpiece W on the mounting unit 140.

The light reception unit 120 is fixed in a tilted posture with respect to the mounting surface 142 of the rotary stage 143. The light reception unit 120 receives the measurement light emitted by the light projection unit 110 and reflected by the workpiece W. In addition, in a case where the holding member 900 is used, the light reception unit 120 receives the measurement light emitted by the light projection unit 110 and reflected by the holding member 900.

When the measurement light is received as the reflected light from the workpiece W and the holding member 900, the light reception unit 120 generates and outputs a light reception signal for measurement indicating the amount of received measurement light. The light reception unit 120 can generate an observation image for observing the entire shape of the workpiece W by capturing the workpiece W mounted on the mounting unit 140. In this example, the illumination light output unit 130 is provided, but the workpiece W and the holding member 900 may be irradiated with uniform light from the light projection unit 110. In this case, the light projection unit 110 is a member that irradiates the workpiece W and the holding member 900 with the measurement light and the uniform light at different timings. The light reception unit 120 can also receive the uniform light emitted from the light projection unit 110 and output a light reception signal for texture acquisition. For example, uniform light having the same wavelength as the measurement light can be emitted from a measurement light source, and a light reception signal including uniaxial color information can be output.

The light reception unit 120 according to the present embodiment includes a high-magnification light reception unit and a low-magnification light reception unit. The high-magnification light reception unit is a portion capable of capturing the workpiece W in an enlarged manner as compared with the low-magnification light reception unit. On the other hand, the low-magnification light reception unit is a light reception unit having a wider field of view range than the high-magnification light reception unit.

The pedestal 600 includes a base plate 602 and a movement control unit (stage control unit) 144. The mounting unit 140 is supported on the base plate 602 of the pedestal 600. The movement control unit 144 is a portion that controls movement and rotation operations of the rotary stage 143 on which the workpiece W is mounted. The movement control unit 144 may be provided on the controller 200 side in addition to being provided on the pedestal 600 side.

The light source unit 300 is connected to the measurement unit 100. The light source unit 300 is a portion that generates the measurement light and supplies the measurement light to the measurement unit 100. The controller 200 is a portion that controls the measurement unit 100 and the like. The display unit 400 is connected to the controller 200, and is configured to display the image generated by the measurement unit 100 and to perform necessary setting, input, selection, and the like.

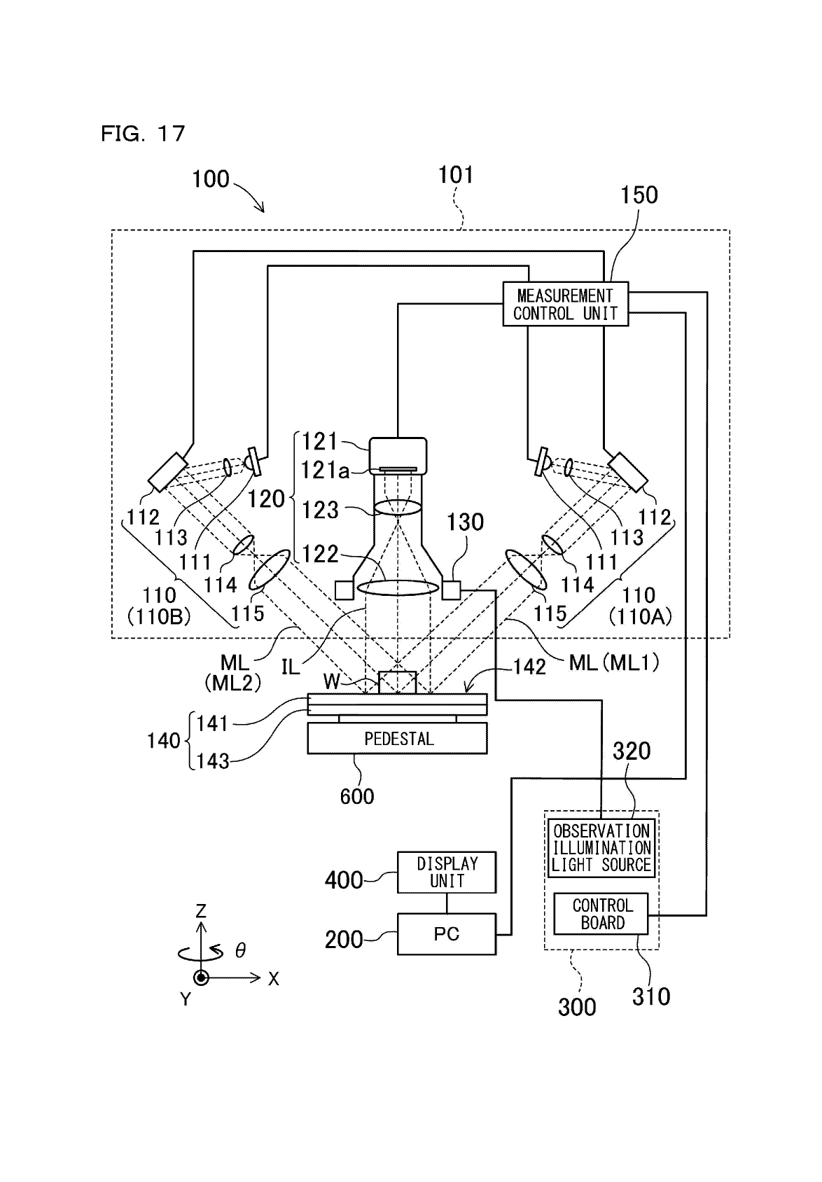

As illustrated in FIG. 17, two directions orthogonal to each other in the mounting surface 142 of the rotary stage 143 are defined as an X direction and a Y direction, and are indicated by arrows X and Y, respectively. A direction orthogonal to the mounting surface 142 of the mounting unit 140 is defined as a Z direction, and is indicated by an arrow Z. A direction of rotation about an axis parallel to the Z direction is defined as a θ direction, and is indicated by an arrow θ.

The mounting unit 140 includes the rotary stage 143 that rotates the mounting surface 142 about an axis extending in the Z direction, and a translation stage 141 that moves the mounting surface 142 in a horizontal direction (X direction and Y direction). The translation stage 141 includes an X-direction moving mechanism and a Y-direction moving mechanism. The rotary stage 143 has a θ-direction rotation mechanism. The mounting unit 140 may include a tilt stage having a mechanism rotatable about an axis parallel to the mounting surface 142.

The movement control unit 144 controls the rotational movement of the rotary stage 143 and the translation of the translation stage 141 according to measurement conditions set by a measurement condition setting unit 261 to be described later. In addition, the movement control unit 144 controls a movement operation of the mounting unit 140 by a mounting movement unit based on a measurement region set by the measurement condition setting unit 261 to be described later.

In addition to the storage device 240, the controller 200 includes a central processing unit (CPU) 210, a read only memory (ROM) 220, a work memory 230, an operation unit 250, and the like. For example, a personal computer (PC) or the like can be used as the controller 200.

A configuration of the measurement unit 100 is illustrated in a block diagram of FIG. 17. The measurement unit 100 includes the light projection unit 110, the light reception unit 120, the illumination light output unit 130, the measurement control unit 150, and a body case 101 that houses these units. The light projection unit 110 includes a measurement light source 111, a pattern generation unit 112, and a plurality of lenses 113, 114, and 115. The light reception unit 120 includes a camera 121 and a plurality of lenses 122 and 123. In a case where measurement is performed at different magnifications by providing a plurality of light reception units, a light reception unit 120a including a camera 121 for low magnification and a lens for low magnification, and a light reception unit 120b including a camera 121 for high magnification and a lens for high magnification may be mounted. Note that, the invention is not limited to this configuration, and the magnification may be variable by switching between a plurality of lenses for one camera 121, or the magnification may be variable by providing a zoom lens for one camera 121.

The light projection unit 110 is arranged obliquely above the mounting unit 140. In the example illustrated in FIG. 17, the measurement unit 100 includes the two light projection units 110, but the measurement unit 100 may include a plurality of light projection units 110. Here, a first measurement light projection unit 110A (right side in FIG. 17) capable of irradiating the workpiece W with first measurement light ML1 from a first direction and a second measurement light projection unit 110B (left side in FIG. 17) capable of irradiating the workpiece W with second measurement light ML2 from a second direction different from the first direction are provided. The first measurement light projection unit 110A and the second measurement light projection unit 110B are arranged symmetrically with respect to an optical axis of the light reception unit 120. Note that, although not illustrated, it is also possible to include three or more light projection units 110, or to relatively move the light projection unit 110 and the mounting unit 140 to project light onto the workpiece W in different illumination directions while using the common light projection unit 110. In addition, in the above example, the plurality of light projection units 110 are prepared and the light rays are received by the common light reception unit 120, but conversely, a plurality of light reception units 120 may be prepared for the common light projection unit 110, and the light rays may be received by the plurality of light reception units. Further, in this example, an irradiation angle of the illumination light projected by the light projection unit 110 with respect to the Z direction is fixed, but this may be variable.

Each of the first measurement light projection unit 110A and the second measurement light projection unit 110B includes, as the measurement light source 111, a first measurement light source and a second measurement light source. The measurement light source 111 is, for example, a halogen lamp that emits white light. The measurement light source 111 may be a light source that emits monochromatic light, for example, another light source such as a blue light emitting diode (LED) or an organic EL that emits blue light. The light (hereinafter, referred to as “measurement light”.) emitted from the measurement light source 111 is appropriately condensed by the lens 113 and is then incident on the pattern generation unit 112.

A relative positional relationship among the light reception unit 120, the light projection units 110A and 110B, and the mounting unit 140 is determined such that central axes of the light projection units 110A and 110B and a central axis of the light reception unit 120 intersect each other at a position where the arrangement of the workpiece W on the mounting unit 140 and depths of field of the light projection unit 110 and the light reception unit 120 are appropriate. In addition, since a center of a rotation axis in the θ direction coincides with the center axis of the light reception unit 120, when the mounting unit 140 rotates in the θ direction, the workpiece W does not deviate from a field of view and rotates in the field of view about the rotation axis.

The pattern generation unit 112 reflects the light emitted from the measurement light source 111 so as to project the measurement light onto the workpiece W. The measurement light incident on the pattern generation unit 112 is converted into a preset pattern and preset intensity (brightness) and emitted. The measurement light emitted by the pattern generation unit 112 is converted into light having a diameter larger than an observable and measurable field of view of the light reception unit 120 by the plurality of lenses 114 and 115, and then the workpiece W on the mounting unit 140 is irradiated with the converted light.

The pattern generation unit 112 is a member capable of switching between a light projection state where the measurement light is projected onto the workpiece W and a non-light projection state where the measurement light is not projected onto the workpiece W. For such a pattern generation unit 112, for example, a digital micromirror device (DMD) or the like can be used. The pattern generation unit 112 using the DMD can be controlled by the measurement control unit 150 to be switchable between a reflection state where the measurement light is reflected on the optical path as the light projection state and a light shielding state where the measurement light is shielded as the non-light projection state.

The DMD is an element in which a large number of micromirrors (micro mirrors) are arrayed on a plane. Since the micromirrors can be individually switched between an ON state and an OFF state by the measurement control unit 150, a desired projection pattern can be formed by combining ON states and OFF states of a large number of micromirrors. As a result, it is possible to generate a pattern necessary for triangulation and measure the shape of the workpiece W. As described above, the DMD functions as a projection pattern optical system that projects a periodic projection pattern for measurement onto the workpiece W at the time of measurement. In addition, the DMD is also excellent in response speed, and has an advantage capable of operating at a higher speed than a shutter or the like.

Note that, in the above example, an example in which the DMD is used for the pattern generation unit 112 has been described, but the pattern generation unit 112 is not limited to the DMD in the invention, and other members can also be used. For example, liquid crystal on silicon (LCOS) may be used as the pattern generation unit 112. Alternatively, the amount of transmitted measurement light may be adjusted by using a transmissive member instead of a reflective member. In this case, the pattern generation unit 112 is arranged on the optical path of the measurement light to switch between a light projection state where the measurement light is transmitted and a light shielding state where the measurement light is shielded. For example, a liquid crystal display (LCD) can be used as the pattern generation unit 112. Alternatively, the pattern generation unit 112 may be formed by a projection method using a plurality of line LEDs, a projection method using a plurality of optical paths, an optical scanner method including a laser and a galvanometer mirror, an accordion fringe interferometry (AFI) method using interference fringes generated by superimposing beams divided by a beam splitter, a projection method using an actual grating and a moving mechanism including a piezo stage, a high-resolution encoder, and the like.

A three-dimensional measurement method may not be a method using the pattern light, and other methods can be used. For example, the camera 121 may be a compound-eye camera, and three-dimensional measurement may be performed by stereo measurement.

The light reception unit 120 is arranged above the mounting unit 140. The measurement light reflected upward from the mounting unit 140 by the workpiece W is collected and captured by the plurality of lenses 122 and 123 of the light reception unit 120, and then received by the camera 121.

The camera 121 is, for example, a charge coupled device (CCD) camera including an imaging element 121a. The imaging element 121a is, for example, a monochrome charge coupled device (CCD). The imaging element 121a may be another imaging element such as a complementary metal oxide semiconductor (CMOS) image sensor. In a color imaging element, since each pixel needs to correspond to light reception for red, green, and blue, measurement resolution is lower than that of a monochrome imaging element. Since a color filter needs to be provided in each pixel, sensitivity is lowered. Thus, in the present embodiment, a color image is acquired by adopting the monochrome CCD as the imaging element and causing the illumination light output unit 130 to be described later to emit illumination corresponding to each of RGB colors in a time division manner to capture an image. With such a configuration, it is possible to acquire a color image of a measurement object without lowering measurement accuracy. The illumination light output unit 130 is an example of a second light projection unit that irradiates the workpiece W with the illumination light. The illumination light can be uniform light.

Note that, the color imaging element may be used as the imaging element 121a. In this case, although the measurement accuracy and sensitivity are lower than those of the monochrome imaging element, it is not necessary to emit illumination corresponding to each of the RGB colors from the illumination light output unit 130 in a time division manner, and the color image can be acquired merely by emitting white light, and thus, an illumination optical system can be simply formed. An analog electric signal (hereinafter, referred to as a “light reception signal”.) corresponding to the amount of received light is output from each pixel of the imaging element 121a to the measurement control unit 150.

An analog/digital converter (A/D converter) and a first-in first-out (FIFO) memory (both are not illustrated) are mounted on the measurement control unit 150. Light reception signals output from the camera 121 are sampled at a constant sampling period and converted into digital signals by the A/D converter of the measurement control unit 150 under the control of the light source unit 300. The digital signals output from the A/D converter are sequentially accumulated in the FIFO memory. The digital signals accumulated in the FIFO memory are sequentially transferred, as pixel data, to the controller 200.

The operation unit 250 of the controller 200 can include, for example, a keyboard, a pointing device, and the like. For example, a mouse, a joystick, or the like is used as the pointing device.

The ROM 220 of the controller 200 stores a system program and the like. The work memory 230 of the controller 200 includes, for example, a random access memory (RAM) and is used for processing various types of data. The storage device 240 stores a program for three-dimensional measurement. In addition, the storage device 240 is used to store various types of data such as pixel data (image data), setting information, and measurement conditions given from the measurement control unit 150. The measurement conditions include, for example, various settings set by a scanner module 260 to be described later when the shape of the workpiece W is measured, such as the setting (pattern frequency or pattern type) of the light projection unit 110 and a type (low-magnification light reception unit or high-magnification light reception unit) of the light reception unit 120. Further, the storage device 240 can also store luminance information, coordinate information, and attribute information every pixel constituting a measurement image.

The CPU 210 is a control circuit or a control element that processes a given signal or data, performs various arithmetic operations, and outputs an arithmetic operation result. In the present specification, the CPU means an element or a circuit that performs the arithmetic operation, and is not limited to a processor such as a CPU, an MPU, a GPU, or a TPU for a general-purpose PC regardless of a name, and is used in the sense of including a processor such as an FPGA, an ASIC, or an LSI, a microcomputer, or a chip set such as an SoC.

The CPU 210 generates image data based on the pixel data given from the measurement control unit 150. In addition, the CPU 210 performs various types of processing on the generated image data by using the work memory 230. For example, the CPU 210 generates measurement data representing the three-dimensional shape of the workpiece W included in the field of view of the light reception unit 120 at a specific position of the mounting unit 140 based on the light reception signal output from the light reception unit 120. The measurement data is the image itself acquired by the light reception unit 120, and for example, in a case where the shape of the workpiece W is measured by a phase shift method, a plurality of images constitute one piece of measurement data. Note that, the measurement data may be point cloud data that is a set of points having three-dimensional position information, and the measurement data of the workpiece W can be acquired from the point cloud data. The point cloud data is data expressed by an aggregate of a plurality of points having three-dimensional coordinates.

The movement control unit 144 determines whether or not to execute only the rotation operation of the rotary stage 143 or to execute both the rotation operation of the rotary stage 143 and the translation operation of the translation stage 141 based on the measurement data of at least a part of the workpiece W. As a result, an imaging range is automatically determined without the user's consciousness in accordance with an outer shape of the workpiece W, and thus, three-dimensional measurement becomes easy. Note that, after the translation stage 141 is moved in an XY direction, the movement control unit 144 can control the rotary stage 143 to rotate in a state where the movement in the XY direction is stopped, and thus, a shape around the workpiece W can also be acquired. Note that, scanning can also be performed by relatively moving and rotating the workpiece W with respect to the measurement unit 100 in a state where the measurement unit 100 is fixed.

The display unit 400 is a member for displaying the fringe projection image acquired by the measurement unit 100, the depth image generated based on the fringe projection image, a texture image captured by the measurement unit 100, various user interface screens, and the like. The display unit 400 includes, for example, an LCD panel or an organic electroluminescence (EL) panel. Further, a touch panel is used for the display unit 400, and thus, it can also be used as the operation unit 250. In addition, the display unit 400 can also display an image generated by the light reception unit 120.

The light source unit 300 includes a control board 310 and an observation illumination light source 320. A CPU (not illustrated) is mounted on the control board 310. The CPU of the control board 310 controls the light projection unit 110, the light reception unit 120, and the measurement control unit 150 based on a command from the CPU 210 of the controller 200. Note that, this configuration is an example, and other configurations may be used. For example, the control board may be omitted by controlling the light projection unit 110 and the light reception unit 120 by the measurement control unit 150 or controlling the light projection unit 110 and the light reception unit 120 by the controller 200. Alternatively, a power supply circuit for driving the measurement unit 100 may be provided in the light source unit 300.

The observation illumination light source 320 includes, for example, LEDs of three colors that emit red light, green light, and blue light. The luminance of the light emitted from each LED is controlled, and thus, light of any color can be generated from the observation illumination light source 320. Illumination light IL generated from the observation illumination light source 320 is output from the illumination light output unit 130 of the measurement unit 100 through a light guide member (light guide). Note that, as the observation illumination light source, other light sources such as a semiconductor laser (LD), a halogen light, and a HID can be appropriately used in addition to the LED. In particular, in a case where an element capable of performing capturing in color is used as the imaging element, a white light source can be used as the observation illumination light source.

The illumination light IL output from the illumination light output unit 130 irradiates the workpiece W with red light, green light, and blue light in a time division manner. As a result, it is possible to obtain a color texture image by combining texture images respectively captured by these RGB lights and display the texture image on the display unit 400.

A three-dimensional measurement program and an application for realizing a function of the three-dimensional scanner 1 by the controller 200 are installed on the controller 200. As a result, a three-dimensional measurement method according to the invention can be executed by using the three-dimensional scanner 1. The three-dimensional measurement method is a method for measuring a three-dimensional shape of the workpiece W, and is executed by a computer included in the controller 200. A three-dimensional measurement program for causing a computer to execute the three-dimensional measurement method can be recorded in a storage medium 1000. The storage medium 1000 may be, for example, an optical disk such as a CD-ROM or a DVD-ROM, or may be a semiconductor memory such as a memory card.

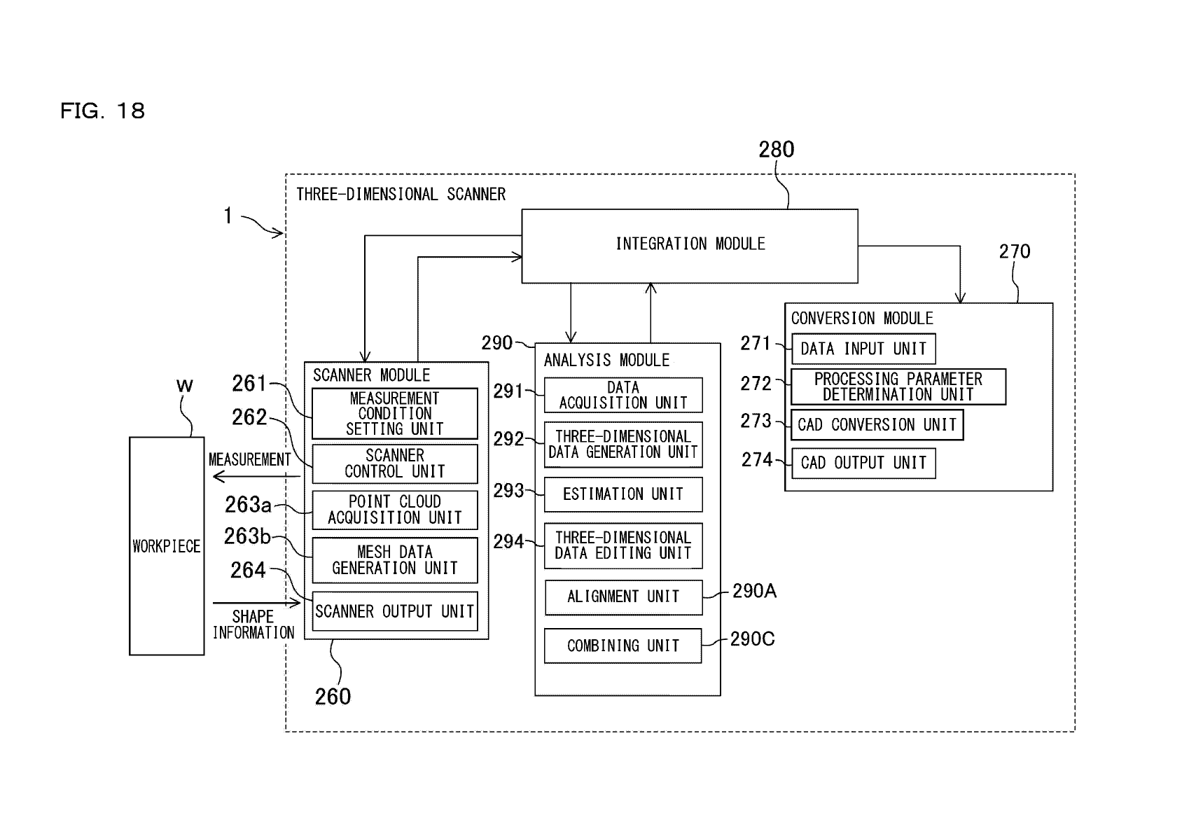

In the controller 200 on which the three-dimensional measurement program and the application are installed, the CPU 210, the ROM 220, the work memory 230, the storage device 240, and the like constitute the scanner module 260, a conversion module 270, an integration module 280, and an analysis module 290 illustrated in FIG. 18. In this embodiment, the scanner module 260, the conversion module 270, the integration module 280, and the analysis module 290 are divided into four modules, but any two or more of the modules 260, 270, 280, and 290 may be integrated to constitute one module. In addition, a part of each of the modules 260, 270, 280, and 290 may be incorporated in another module. That is, the configuration example illustrated in FIG. 18 is an example, and is not limited to the configuration example illustrated in FIG. 18.

The scanner module 260 is a portion that acquires image data of the workpiece W by measuring the shape of the workpiece W and creates mesh data of the workpiece W based on the image data. The conversion module 270 is a portion that converts the mesh data created by the scanner module 260 into CAD data. The CAD data is three-dimensional shape information constituted by an analytical curved surface and a free-form surface, and includes surface data, solid data, data used for design, and the like. The surface data is data of a shape surface including a free-form surface and an analytical curved surface, such as side surface data and plane data of a cylinder.

The integration module 280 is a portion that transmits signals and data from the scanner module 260 to the conversion module 270 and the analysis module 290, and transmits signals and data from the conversion module 270 to the scanner module 260. In the present example, the module can execute a plurality of kinds of arithmetic processing in one unit, and can also be referred to as a functional unit, a functional block, or the like, for example.

The scanner module 260 includes, for example, the measurement condition setting unit 261, a scanner control unit 262, a point cloud acquisition unit 263a, a mesh data generation unit 263b, a scanner output unit 264, and the like. The measurement condition setting unit 261 is a portion for setting a measurement condition of the shape of the workpiece. The scanner control unit 262 is portion that controls the measurement unit 100 according to the measurement condition set by the measurement condition setting unit 261 to generate image data and acquires measurement data of the workpiece W based on the generated image data.

The point cloud acquisition unit 263a is a portion that acquires the point cloud data of the workpiece W based on the image data of the workpiece W acquired by the scanner control unit 262. The mesh data generation unit 263b is a portion that acquires the point cloud data acquired by the point cloud acquisition unit 263a, processes the acquired point cloud data, and converts the data into mesh data.

The scanner output unit 264 is a portion that outputs the mesh data created by the mesh data generation unit 263b and additional data to the conversion module 270. The additional data is, for example, data including at least one of the measurement condition and data calculated from the measurement data of the workpiece W.

The scanner module 260 controls the measurement unit 100, and generates conditions (measurement device model, measurement magnification, resolution, and the like) under which the shape of the workpiece W has been measured and Raw data (for example, image data) at the time of measurement together with three-dimensional data. The three-dimensional data is mesh data including a plurality of polygons, and can also be referred to as polygon data. The polygon is data including information specifying a plurality of points and information indicating a polygonal surface formed by connecting the points, and can include, for example, information specifying three points and information indicating a triangular surface formed by connecting the three points. The mesh data and the polygon data can also be defined as data expressed by an aggregate of a plurality of polygons.

In the conversion module 270, the mesh data is converted into CAD data, and conversion processing is determined based on the measurement condition and Raw data. Specifically, the conversion module 270 includes, for example, a data input unit 271, a processing parameter determination unit 272, a CAD conversion unit 273, a CAD output unit 274, and the like. The data input unit 271 is a portion that accepts the mesh data output from the scanner output unit 264 and the additional data. The processing parameter determination unit 272 is a portion that determines a processing parameter when the mesh data is converted into the CAD data according to the additional data accepted by the data input unit 271. The CAD conversion unit 273 is a portion that converts the mesh data into the CAD data according to the processing parameter determined by the processing parameter determination unit 272. The CAD output unit 274 is a portion that outputs the CAD data converted by the CAD conversion unit 273.

The analysis module 290 of the three-dimensional scanner 1 is a module that generates combined three-dimensional data of the workpieces W by generating pieces of three-dimensional data of workpieces W arranged in different arrangement postures and combining the pieces of three-dimensional data. The analysis module 290 includes a data acquisition unit 291 that receives the light reception signal output from the light reception unit 120. That is, the data acquisition unit 291 acquires the light reception signal based on the measurement light reflected by the holding member 900 and the workpiece W. Further, the data acquisition unit 291 acquires a two-dimensional image including the identification members 900A, 900B, 900C, and 900D provided on the holding member 900 based on the light reception signal output from the light reception unit 120. That is, the camera 121 is a member that outputs the light reception signal based on the measurement light reflected by the holding member 900 and the workpiece W, and outputs the two-dimensional image including the identification members 900A, 900B, 900C, and 900D provided on the holding member 900. The two-dimensional image is not an image acquired by structured illumination, but is an image acquired in a state where a front surface (including the identification members 900A, 900B, 900C, 900D) of the holding member 900 is irradiated with, for example, the uniform light. Note that, a pseudo uniform light image obtained by performing the arithmetic processing on the image acquired by structured illumination may be used.

Depending on a positional relationship between the optical axis of the light reception unit 120 and the holding member 900, the data acquisition unit 291 may not be able to acquire the two-dimensional image including all the identification members 900A, 900B, 900C, and 900D. In this case, the data acquisition unit 291 acquires a two-dimensional image including some identification members among the identification members 900A, 900B, 900C, and 900D.

In the present embodiment, since the identification members 900A, 900B, 900C, and 900D are provided on the different surfaces of the holding member 900, the positions of the identification members 900A, 900B, 900C, and 900D are all different. In addition, since the first identification member 900A on the far side and the first identification member 900B on the near side are directed to different directions, at least one identification member easily enters the imaging range of the light reception unit 120. The same applies to the second identification members 900C and 900D.

The user can mount the workpiece W on the rotary stage 143 in any posture. For example, in a case where three-dimensional shapes of a front side and a back side of the workpiece W are acquired, the three-dimensional data can be acquired by mounting the workpiece W on the rotary stage 143 in an arrangement posture in which the front side of the workpiece W faces upward to acquire the three-dimensional data and then mounting the workpiece W on the rotary stage 143 in an arrangement posture in which the back side of the workpiece W faces upward to acquire the three-dimensional data. In addition, in a case where a three-dimensional shape of a side surface of the workpiece W is acquired, the three-dimensional data can be acquired by mounting the workpiece W on the rotary stage 143 in an arrangement posture in which the side surface of the workpiece W faces upward. For example, the arrangement posture in which the front side of the workpiece W faces upward can be set as a first arrangement posture, and the arrangement posture in which the back side of the workpiece W faces upward can be set as a second arrangement posture. In addition, the arrangement posture in which the side surface of the workpiece W faces upward may be a third arrangement posture. The holding member 900 is used, and thus, the workpiece W can be held in various arrangement postures on the rotary stage 143.

The definition of the arrangement posture of the workpiece W is an example, and the arrangement postures may be different from each other. For example, the first arrangement posture, the second arrangement posture, and the third arrangement posture can be defined in accordance with the shape of the workpiece W, a range in which three-dimensional data is desired to be acquired, and the like. In addition, a fourth arrangement posture and a fifth arrangement posture may be defined, and the number of arrangement postures is not particularly limited.

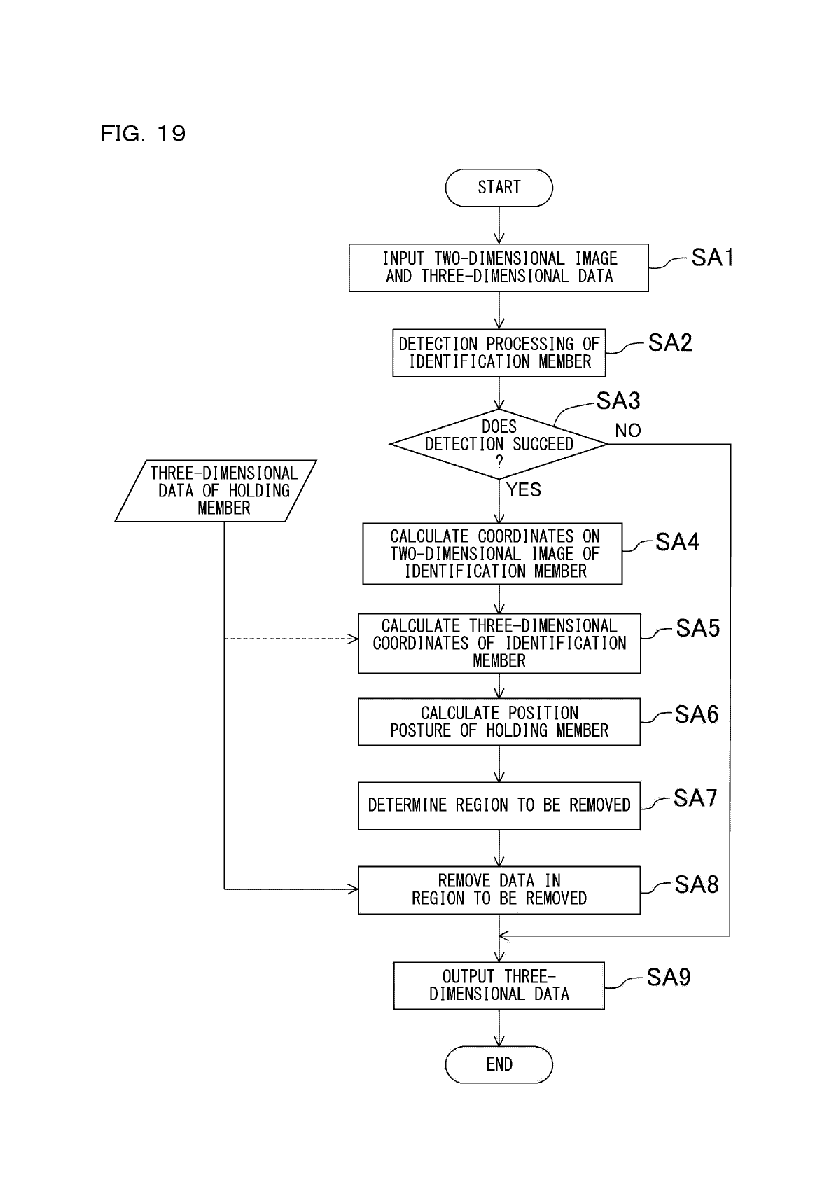

In a case where the holding member 900 is used, since the holding member 900 is also measured together with the workpiece W as described above, it is necessary to remove the three-dimensional data of the holding member 900 after the measurement. FIG. 19 is a flowchart illustrating a flow of processing of removing the three-dimensional data of the holding member 900 after measurement. In step SA1, the two-dimensional image and the three-dimensional data are input. That is, the analysis module 290 includes a three-dimensional data generation unit 292, and the three-dimensional data generation unit 292 acquires the light reception signal acquired by the data acquisition unit 291. The three-dimensional data generation unit 292 generates the first three-dimensional data including the three-dimensional data of the holding member 900 and the three-dimensional data of the workpiece W based on the light reception signal acquired by the data acquisition unit 291. The data acquisition unit 291 may acquire the two-dimensional image including the identification members 900A, 900B, 900C, and 900D, and associate the first three-dimensional data with the two-dimensional image. In addition, in a case where the workpiece W is captured from a plurality of different viewpoints, a two-dimensional image corresponding to each viewpoint may be associated with the first three-dimensional data.

In step SA2, an estimation unit 293 included in the analysis module 290 detects the identification members 900A, 900B, 900C, and 900D provided on the holding member 900. Specifically, first, the estimation unit 293 acquires the two-dimensional image acquired by the data acquisition unit 291. The estimation unit 293 executes detection processing of the identification members 900A, 900B, 900C, and 900D as to whether or not the identification members 900A, 900B, 900C, and 900D are included in the two-dimensional image acquired by the data acquisition unit 291. When one of the identification members 900A, 900B, 900C, and 900D is detected as a result of the detection processing, the estimation unit 293 determines in step SA3 that the detection succeeds. As a result of the detection processing, in a case where none of the identification members 900A, 900B, 900C, and 900D is detected, the estimation unit 293 determines in step SA3 that the detection fails. Among the identification members 900A, 900B, 900C, and 900D, any identification member may be detected, and the number of detected identification members may be one or two or more. However, in the following description, for the sake of convenience, the identification members are described as the “identification members 900A, 900B, 900C, and 900D”.

In a case where it is determined in step SA3 that the detection fails, the processing proceeds to step SA9, and the first three-dimensional data generated in step SA1 is output as it is. On the other hand, in a case where it is determined in step SA3 that the detection succeeds, the processing proceeds to step SA4. In step SA4, the estimation unit 293 calculates and specifies coordinates (two-dimensional coordinates) indicating a region where the identification members 900A, 900B, 900C, and 900D are present based on the two-dimensional image of the identification members 900A, 900B, 900C, and 900D detected in step SA3. In a case where the AR markers are the identification members 900A, 900B, 900C, and 900D, since the AR markers are designed to accurately obtain coordinates of four corners, the accuracy of the coordinates calculated in step SA4 can be increased. In addition, the estimation unit 293 acquires the IDs included in the identification members 900A, 900B, 900C, and 900D based on the two-dimensional image acquired by the data acquisition unit 291. In addition, luminance or color information may be extracted from the two-dimensional image, and the extracted luminance or color information may be given to each point of a three-dimensional point cloud corresponding to each pixel on the two-dimensional image. The coordinates (three-dimensional coordinates) indicating the region where the identification members are present may be calculated by using the luminance or color information given to each point of the three-dimensional point cloud. Further, the two-dimensional image may be regenerated from the luminance or color information given to each point of the three-dimensional point cloud, and the coordinates (two-dimensional coordinates) indicating the region where the identification members are present may be calculated by using the two-dimensional image.

In step SA5, the estimation unit 293 calculates and specifies three-dimensional coordinates corresponding to the two-dimensional coordinates of the identification members 900A, 900B, 900C, and 900D detected in step SA3. Specifically, three-dimensional coordinates of image coordinates where the identification members 900A, 900B, 900C, and 900D are present can be obtained by using the three-dimensional data input in step SA1. For example, the estimation unit 293 can specify the three-dimensional coordinates indicating the region where the identification members are present by acquiring the three-dimensional information in the coordinates corresponding to the two-dimensional coordinates where the identification members are present from the first three-dimensional data generated by the three-dimensional data generation unit 292 based on the light reception signal acquired by the data acquisition unit 291. The three-dimensional information at the coordinates corresponding to the two-dimensional coordinates where the identification members are present may be specified by using calibration information including internal parameters and external parameters of a camera and a projector in addition to the light reception signal acquired by the data acquisition unit 291. Here, the calibration information is information including an internal parameter of a camera that acquires an image, an internal parameter of a projector, and an external parameter between the camera and the projector in a case where acquisition of an image for three-dimensional data and acquisition of an image including an identifier are performed by the same camera, and is information including an internal parameter of each camera, an internal parameter of a projector, an external parameter between the cameras, and an external parameter between each camera and the projector in a case where acquisition of an image for three-dimensional data and acquisition of an image including an identifier are performed by different cameras. In addition, relative positional relationships between the camera 121 and the identification members 900A, 900B, 900C, and 900D can be calculated by using a technique called Perspective-n-Point (PnP) based on the image coordinates of the four corners. As a result, position postures of the identification members 900A, 900B, 900C, and 900D can be specified. In addition, in step SA5, the three-dimensional data of the holding member 900 may be used when the position postures of the identification members 900A, 900B, 900C, and 900D are specified.

In step SA6, the estimation unit 293 calculates the position posture of the holding member 900. For example, three-dimensional coordinates in which centers of the identification members 900A, 900B, 900C, and 900D are present, reference coordinates of the identification members 900A, 900B, 900C, and 900D, and a rotational relationship of camera coordinate axes can be obtained. These obtained coordinates and rotational relationship are referred to as “postures” of the identification members 900A, 900B, 900C, and 900D. In a case where a plurality of identification members 900A, 900B, 900C, and 900D are detected, this processing is performed a plurality of number of times, and the postures of the identification members 900A, 900B, 900C, and 900D are calculated. That is, the estimation unit 293 can specify the position postures of the identification members 900A, 900B, 900C, and 900D based on the two-dimensional image acquired by the data acquisition unit 291.

In step SA6, the estimation unit 293 estimates the position posture of the holding member 900 based on the specified position postures of the identification members 900A, 900B, 900C, and 900D. First, which identification members 900A, 900B, 900C, and 900D are present at which three-dimensional positions in the coordinate system of the holding member 900, specifically, the three-dimensional postures (positions and directions) of the identification members 900A, 900B, 900C, and 900D at the reference coordinates (the reference axis and the origin) of the holding member 900 can be stored in the storage device 240 or the like in advance to be known.

The holding member 900 includes the adjustment mechanism 940. In this case, the coordinates of the identification member provided in the fixed portion serving as the reference (for example, the first arm 910) are fixed, and in the movable portion (for example, the second arm 920), only a degree of freedom of the movement (the amount of parallel movement accompanying an opening and closing operation) is indefinite.

The position posture of the holding member 900 can be estimated based on the position posture of at least one identification member, but the position posture of the holding member 900 having the adjustment mechanism 940 can be accurately estimated by specifying a plurality of identification members having different IDs. That is, in the present embodiment, since the first identification members 900A and 900B and the second identification members 900C and 900D are provided in one holding member 900, the estimation unit 293 can specify the first identification members 900A and 900B and the second identification members 900C and 900D, depending on the position posture of the holding member 900 on the rotary stage 143. In a case where the position postures of the first identification members 900A and 900B and the position postures of the second identification members 900C and 900D are specified, the estimation unit 293 estimates the positional relationship between the first arm 910 and the second arm 920 adjusted by the adjustment mechanism 940 based on the position postures of the first identification members 900A and 900B and the position postures of the second identification members 900C and 900D.

In step SA7, a region to be removed from the first three-dimensional data generated in step SA1, that is, a region where the holding member 900 is present is determined. The region to be removed is determined by a three-dimensional data editing unit 294 included in the analysis module 290. The region to be removed may be a simple three-dimensional rotating rectangle, a region formed by a combination of simple figures including a plurality of rectangles or cylinders, a region including a complex mesh based on CAD data of the holding member 900, or the like.

In the case of the present embodiment, the identification members 900A, 900B, 900C, and 900D are provided in both the first arm 910 and the second arm 920 of the holding member 900, and in a case where the identification members 900A, 900B, 900C, and 900D of both the first arm 910 and the second arm 920 are specified, the entire shape of the holding member 900 can be formed with postures of a plurality of corresponding parts. The three-dimensional data editing unit 294 sets the entire shape of the holding member 900 as the region to be removed from the first three-dimensional data. At this time, parts of the shape corresponding to the first arm 910 and the shape corresponding to the second arm 920 may overlap, and removal regions corresponding to the identification members may overlap. In this case, it is possible to suppress three-dimensional data of a connection portion between the first arm 910 and the second arm 920 from remaining without being erased.

At this time, in a case where the identification members 900A, 900B, 900C, and 900D corresponding to all the parts are not specified, the position posture of the holding member 900 can be estimated only from the specified identification member, and a large region in consideration of a movable range of the holding member 900 by the adjustment mechanism 940 can be removed. When a large number of identification members 900A, 900B, 900C, and 900D are specified, the region to be removed can be determined with high accuracy. On the other hand, when the number of identification members 900A, 900B, 900C, and 900D identified is small, the region to be removed is increased. However, the three-dimensional data of the holding member 900 can be reliably removed in subsequent step SA8.

In step SA8, the three-dimensional data editing unit 294 performs processing of removing the three-dimensional data in the region to be removed determined in step SA7 from the first three-dimensional data generated in step SA1, and generates second three-dimensional data. In step SA8, the three-dimensional data in the region to be removed may be removed by using the three-dimensional data of the holding member 900.

In addition, in a case where the ID of the identification member is acquired by the estimation unit 293, the three-dimensional data editing unit 294 acquires the position of the identification member and the shape of the holding member 900 associated with the ID acquired by the estimation unit 293 from the storage device 240. Then, in step SA8, the three-dimensional data editing unit 294 generates second three-dimensional data obtained by removing the three-dimensional data of the holding member 900 from the first three-dimensional data generated in step SA1 based on the position of the identification member and the shape of the holding member 900 acquired from the storage device 240.

It is conceivable that the specification of the position posture of one identification member of the first identification members 900A and 900B and the second identification members 900C and 900D fails and the specification of only the position posture of the other identification member succeeds due to, for example, the one identification member is positioned outside the imaging range. In this case, in a case where the specification of the position posture of one identification member of the first identification members 900A and 900B and the second identification members 900C and 900D fails and the specification of the position posture of the other identification member succeeds, the three-dimensional data editing unit 294 removes the three-dimensional data of the holding member 900 from the first three-dimensional data based on the shape of the holding member 900 in which the distance between the first workpiece holding surface 912 and the second workpiece holding surface 922 of the holding member 900 is in a predetermined state, and generates the second three-dimensional data. For example, the three-dimensional data in a state where the arms 910 and 920 are fully closed may be removed from the first three-dimensional data, the three-dimensional data in a state where the arms 910 and 920 are fully opened may be removed from the first three-dimensional data, or the three-dimensional data in a state where the arms 910 and 920 are at any degrees of opening may be removed from the first three-dimensional data.

In step SA9, the second three-dimensional data generated by the three-dimensional data editing unit 294 is output. The second three-dimensional data can be displayed on the display unit 400 or output to the conversion module 270, for example. Note that, a plurality of holding members 900 may be arranged. At this time, an identification member different from the holding member 900 is provided, and thus, each holding member may be made identifiable. In addition, in a case where a plurality of holding members using the same identification member are arranged, that is, in a case where the first holding member 900 and a second holding member 900’ to which the same identification member as that of the first holding member is provided are arranged, the estimation unit 293 specifies the position posture from each identification member based on the two-dimensional image acquired by the data acquisition unit 291. Then, the position postures of the first holding member 900 and the second holding member 900’ are estimated based on the specified position posture of each identification member. At this time, since a plurality of identification members are provided on the first holding member 900 and the second holding member 900’, a plurality of position posture candidates may be estimated as the position posture of each holding member. In this case, among the plurality of estimated position posture candidates, a position posture candidate estimated to be present within a predetermined angular range or within a predetermined distance range such as within an angular range of 5 degrees or within a distance range of 10 mm may be regarded as a position posture corresponding to the same holding member, and a position posture candidate estimated to be present within a range separated from the predetermined angular range or the predetermined distance range may be regarded as a position posture corresponding to a different holding member. That is, the estimation unit 293 may estimate a position posture candidate corresponding to the same holding member from the plurality of position posture candidates based on an angle or a distance, and the three-dimensional data editing unit 294 may remove the three-dimensional data corresponding to the first holding member 900 and the three-dimensional data corresponding to the second holding member 900’ from the first three-dimensional data based on the position posture candidate corresponding to the same holding member estimated by the estimation unit 293. That is, the three-dimensional data corresponding to the first holding member 900 and the three-dimensional data corresponding to the second holding member 900’ considered to be present at a different position from the first member 900 may be removed from the first three-dimensional data.

### Measurement of first arrangement posture and second arrangement posture

In the present embodiment, the measurement of the workpiece W can be executed in both the state where the workpiece W is arranged in the first arrangement posture and the state where the workpiece W is arranged in the second arrangement posture. In this case, the data acquisition unit 291 acquires the light reception signal based on the measurement light reflected by the workpiece W arranged in the first arrangement posture and the holding member 900, and acquires the light reception signal based on the measurement light reflected by the workpiece W arranged in the second arrangement posture and the holding member 900. In addition, the data acquisition unit 291 acquires the two-dimensional image including the identification members 900A, 900B, 900C, and 900D when the workpiece W is in the first arrangement posture, and acquires the two-dimensional image including the identification members 900A, 900B, 900C, and 900D when the workpiece W is in the second arrangement posture.

The three-dimensional data generation unit 292 generates the first three-dimensional data including the three-dimensional data of the holding member 900 and the workpiece W from the light reception signal based on the measurement light reflected by the workpiece W arranged in the first arrangement posture and the holding member 900. Further, the three-dimensional data generation unit 292 generates the third three-dimensional data including the three-dimensional data of the holding member 900 and the workpiece W from the light reception signal based on the measurement light reflected by the workpiece W arranged in the second arrangement posture and the holding member 900. Note that, the first three-dimensional data and the third three-dimensional data may be generated based on a plurality of light reception signals acquired while changing the rotational positions of the workpiece W arranged in the first arrangement posture or the second arrangement posture and the holding member 900.

The estimation unit 293 specifies first position postures of the identification members 900A, 900B, 900C, and 900D based on the two-dimensional image acquired when the workpiece is in the first arrangement posture, and estimates a first position posture of the holding member 900 based on the specified first position postures of the identification members 900A, 900B, 900C, and 900D. Further, the estimation unit 293 specifies second position postures of the identification members 900A, 900B, 900C, and 900D based on the two-dimensional image acquired when the workpiece is in the second arrangement posture, and estimates a second position posture of the holding member 900 based on the specified second position postures of the identification members 900A, 900B, 900C, and 900D. In a case where the first three-dimensional data and the third three-dimensional data are generated based on the plurality of light reception signals acquired while changing the rotational positions of the workpiece W and the holding member 900, the position postures of the identification members 900A, 900B, 900C, and 900D may be specified based on at least one two-dimensional image acquired at each rotational angle.

The three-dimensional data editing unit 294 generates second three-dimensional data obtained by removing the three-dimensional data of the holding member 900 from the first three-dimensional data generated by the three-dimensional data generation unit 292 based on the first position posture of the holding member 900 estimated by the estimation unit 293. Further, the three-dimensional data editing unit 294 generates fourth three-dimensional data obtained by removing the three-dimensional data of the holding member 900 from the third three-dimensional data generated by the three-dimensional data generation unit 292 based on the second position posture of the holding member 900 estimated by the estimation unit 293.

An alignment unit 290A included in the analysis module 290 acquires the second three-dimensional data and the fourth three-dimensional data generated by the three-dimensional data editing unit 294. Then, the alignment unit 290A performs alignment between the acquired second three-dimensional data and fourth three-dimensional data. At the time of this alignment, the alignment unit 290A estimates an overlap region between the second three-dimensional data and the fourth three-dimensional data, and uses an overlap region between the estimated two postures. The alignment unit 290A can estimate the overlap region between the second three-dimensional data and the fourth three-dimensional data by using, for example, a normal vector of the three-dimensional data, the color information of the workpiece W, and the like. That is, the alignment unit 290A can perform alignment based on the three-dimensional data included in the estimated overlap region.

A combining unit 290C included in the analysis module 290 is a portion that combines the second three-dimensional data and the fourth three-dimensional data aligned by the alignment unit 290A. In a case where the second three-dimensional data and the fourth three-dimensional data are pieces of mesh data, the combining unit 290C combines both the pieces of mesh data to generate combined mesh data as combined three-dimensional data.

### Embodiment including first camera and second camera

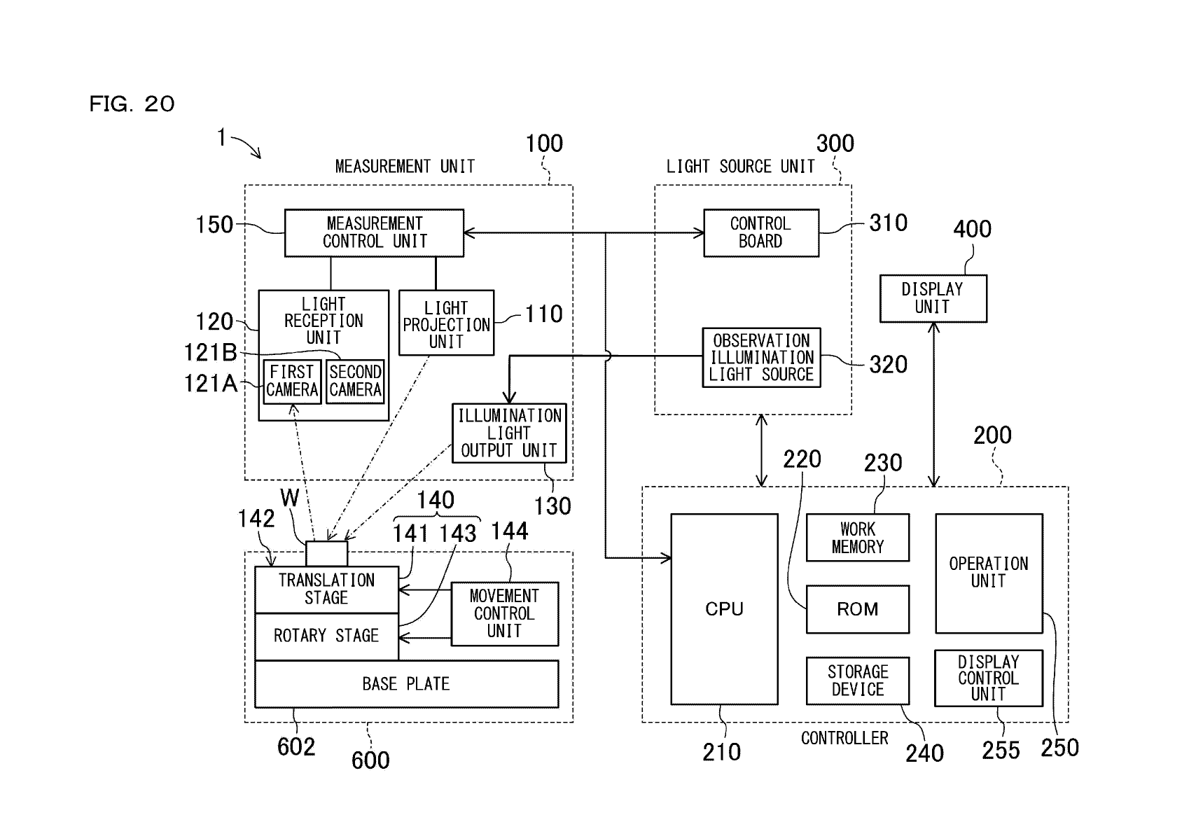

In the above embodiment, the three-dimensional scanner 1 includes the single camera 121, but the invention is not limited thereto. As in a modification illustrated in FIG. 20, the three-dimensional scanner 1 may include a first camera 121A that outputs a light reception signal based on the measurement light reflected by the holding member 900 and the workpiece W, and a second camera 121B that has coordinates associated with the coordinates of the first camera 121A and outputs the two-dimensional image including the identification members 900A, 900B, 900C, and 900D provided on the holding member 900. Coordinates of the first camera 121A and coordinates of the second camera 121B are associated with each other based on an internal parameter of the first camera 121A, an internal parameter of the second camera 121B, and an external parameter of the second camera 121B with respect to the first camera 121A. The internal parameters include lens and pixel modeling (focal length or the like). In addition, the external parameter includes a relative relationship between reference points (principal points of lenses) of the first camera 121A and the second camera 121B.

In this modification, the data acquisition unit 291 acquires the light reception signal output from the first camera 121A and the two-dimensional image output from the second camera 121B. The estimation unit 293 specifies two-dimensional coordinates indicating the region where the identification members 900A, 900B, 900C, and 900D are present based on the two-dimensional image output by the second camera 121B and acquired by the data acquisition unit 291. In addition, the estimation unit 293 specifies three-dimensional coordinates corresponding to the two-dimensional coordinates indicating the region where the identification members 900A, 900B, 900C, and 900D are present based on the light reception signal output by the first camera 121A and acquired by the data acquisition unit 291. Then, the estimation unit 293 estimates the position postures of the identification members 900A, 900B, 900C, and 900D based on the specified three-dimensional coordinates.

When the three-dimensional coordinates are specified, the estimation unit 293 acquires the first three-dimensional data generated by the three-dimensional data generation unit 292 based on the light reception signal output by the first camera 121A and acquired by the data acquisition unit 291. The estimation unit 293 specifies the three-dimensional coordinates indicating the region where the identification members 900A, 900B, 900C, and 900D are present by acquiring three-dimensional information at coordinates corresponding to the two-dimensional coordinates indicating the region where the identification members 900A, 900B, 900C, and 900D are present from the first three-dimensional data. In addition, the first camera 121A may be a compound-eye camera, and three-dimensional measurement may be performed by stereo measurement.

### Other embodiments

The above-described embodiment is merely an example in all respects, and should not be construed in a limiting manner. Further, all modifications and changes falling within the equivalent scope of the claims are within the scope of the invention. For example, the shape, size, position, and the like of each member can be appropriately changed as necessary.

For example, pieces of data whose mutual geometric relationship is known, such as the plurality of pieces of three-dimensional data acquired by using the rotary stage 143 are integrated, and thus, it is also possible to erase the three-dimensional data of the holding member 900 measured at the time of another capturing based on information of the identification member at the time of a certain capturing. This can be realized by converting the three-dimensional data acquired at the time of another capturing into the coordinate system at the time of capturing in which the identification member to be used is measured by a conversion matrix representing a geometric relationship between the kinds of capturing, and removing the three-dimensional data of the holding member 900 based on the coordinates of the identification member. These are only differences of a plurality of cameras or a plurality of times of capturing, and are the same in that the holding member 900 is removed by integrating a plurality of pieces of three-dimensional data having a known relative positional relationship.

In addition, in a case where the above-described height adjustment member is detachably attached to the holding member 900, the height adjustment member may be attached to the holding member 900, and the holding member 900 may be fixed at any height for use. At that time, a maximum height and an orientation of the holding member 900 are detected from the three-dimensional coordinates of the holding member 900 in the device coordinate system, and in a case where it is determined that the height is equal to or greater than a certain value and the mounting surface of the height adjustment member is directed downward, it is determined that the height adjustment member is used. As the region to be removed, a region including a region of the holding member 900 and a region obtained by expanding the region of the holding member 900 until the region comes into contact with the upper surface of the rotary stage 143 is set, and the height adjustment member can also be removed.

As described above, the invention can be used to generate pieces of three-dimensional data of various workpieces.

What is claimed is:

1. A three-dimensional scanner that irradiates a workpiece with measurement light from a light projection unit and generates three-dimensional data of the workpiece based on the measurement light reflected by the workpiece, the three-dimensional scanner comprising:
a holding member that holds the workpiece;
an identification member that is provided on the holding member and specifies a position posture of the holding member;
a data acquisition unit that acquires a light reception signal based on the measurement light reflected by the holding member and the workpiece and acquires a two-dimensional image including the identification member provided on the holding member;
a three-dimensional data generation unit that generates first three-dimensional data including pieces of three-dimensional data of the holding member and the workpiece based on the light reception signal acquired by the data acquisition unit;
an estimation unit that specifies a position posture of the identification member based on the two-dimensional image acquired by the data acquisition unit, and estimates a position posture of the holding member based on the specified position posture of the identification member; and
a three-dimensional data editing unit that generates second three-dimensional data by removing the three-dimensional data of the holding member from the first three-dimensional data generated by the three-dimensional data generation unit based on the position posture of the holding member estimated by the estimation unit.

2. The three-dimensional scanner according to claim 1, wherein the identification member is an AR marker.

3. The three-dimensional scanner according to claim 1, wherein
the holding member includes a first member having a first workpiece holding surface that holds the workpiece, a second member having a second workpiece holding surface that holds the workpiece, and an adjustment mechanism that relatively moves the first member and the second member in a direction in which the first workpiece holding surface and the second workpiece holding surface come into contact with and separate from each other,
the identification member includes a first identification member provided on the first member and a second identification member provided on the second member, and
the estimation unit specifies a position posture of the first identification member and a position posture of the second identification member, and estimates a positional relationship between the first member and the second member adjusted by the adjustment mechanism based on the position posture of the first identification member and the position posture of the second identification member.

4. The three-dimensional scanner according to claim 3, wherein
a plurality of the first identification members are provided on the first member at intervals, and
a plurality of the second identification members are provided on the second member at intervals.

5. The three-dimensional scanner according to claim 3, wherein
the identification member includes an ID for specifying the identification member,
the three-dimensional scanner further includes a storage unit that stores data in which the ID, a position of the identification member on the holding member, and a shape of the holding member are associated with each other,
the estimation unit acquires the ID based on the two-dimensional image acquired by the data acquisition unit, and
the three-dimensional data editing unit acquires the position of the identification member and the shape of the holding member associated with the ID acquired by the estimation unit from the storage unit, and generates the second three-dimensional data by removing the three-dimensional data of the holding member from the first three-dimensional data based on the acquired position of the identification member and the acquired shape of the holding member.

6. The three-dimensional scanner according to claim 5, wherein
the storage unit stores a shape of the holding member in which a distance between the first workpiece holding surface and the second workpiece holding surface is in a predetermined state, and
the three-dimensional data editing unit generates the second three-dimensional data from the first three-dimensional data based on the shape of the holding member in which the distance between the first workpiece holding surface and the second workpiece holding surface is in the predetermined state in a case where specification of a position posture of one identification member of the first identification member and the second identification member fails and specification of a position posture of the other identification member succeeds.

7. The three-dimensional scanner according to claim 1, wherein
the data acquisition unit acquires a light reception signal based on measurement light reflected by the workpiece arranged in a first arrangement posture and the holding member, and acquires a light reception signal based on measurement light reflected by the workpiece arranged in a second arrangement posture and the holding member,
the three-dimensional data generation unit generates the first three-dimensional data including the pieces of three-dimensional data of the holding member and the workpiece by the light reception signal based on the measurement light reflected by the workpiece arranged in the first arrangement posture and the holding member, and generates third three-dimensional data including the pieces of three-dimensional data of the holding member and the workpiece by the light reception signal based on the measurement light reflected by the workpiece arranged in the second arrangement posture and the holding member,
the estimation unit specifies a first position posture of the identification member based on the two-dimensional image acquired when the workpiece is in the first arrangement posture, estimates a first position posture of the holding member based on the specified first position posture of the identification member, specifies a second position posture of the identification member based on the two-dimensional image acquired when the workpiece is in the second arrangement posture, and estimates a second position posture of the holding member based on the specified second position posture of the identification member,
the three-dimensional data editing unit generates the second three-dimensional data by removing the three-dimensional data of the holding member from the first three-dimensional data generated by the three-dimensional data generation unit based on the first position posture of the holding member estimated by the estimation unit, and generates fourth three-dimensional data by removing the three-dimensional data of the holding member from the three-dimensional data generated by the three-dimensional data generation unit based on the second position posture of the holding member estimated by the estimation unit, and
the three-dimensional scanner further includes
an alignment unit that aligns the second three-dimensional data and the fourth three-dimensional data generated by the three-dimensional data editing unit, and
a combining unit that combines the second three-dimensional data and the fourth three-dimensional data aligned by the alignment unit.

8. The three-dimensional scanner according to claim 7, wherein the alignment unit estimates an overlap region between the second three-dimensional data and the fourth three-dimensional data, and aligns the second three-dimensional data and the fourth three-dimensional data based on three-dimensional data included in the estimated overlap region.

9. The three-dimensional scanner according to claim 1, further comprising:
a camera that outputs the light reception signal based on the measurement light reflected by the holding member and the workpiece and outputs the two-dimensional image including the identification member provided on the holding member,
wherein the data acquisition unit acquires the light reception signal and the two-dimensional image output by the camera, and
the estimation unit
specifies two-dimensional coordinates indicating a region where the identification member is present based on the two-dimensional image acquired by the data acquisition unit,
specifies three-dimensional coordinates corresponding to the two-dimensional coordinates based on the light reception signal acquired by the data acquisition unit, and
estimates the position posture of the identification member based on the specified three-dimensional coordinates.

10. The three-dimensional scanner according to claim 9, wherein the estimation unit specifies the three-dimensional coordinates indicating the region where the identification member is present by acquiring three-dimensional information at coordinates corresponding to the two-dimensional coordinates from the first three-dimensional data generated by the three-dimensional data generation unit based on the light reception signal acquired by the data acquisition unit.

11. The three-dimensional scanner according to claim 1, further comprising:
a first camera that outputs the light reception signal based on the measurement light reflected by the holding member and the workpiece; and
a second camera that has coordinates associated with coordinates of the first camera and outputs the two-dimensional image including the identification member provided on the holding member,
wherein the data acquisition unit acquires the light reception signal output by the first camera and the two-dimensional image output by the second camera,
the estimation unit
specifies the two-dimensional coordinates indicating the region where the identification member is present based on the two-dimensional image output by the second camera and acquired by the data acquisition unit,
specifies three-dimensional coordinates corresponding to the two-dimensional coordinates based on the light reception signal output by the first camera and acquired by the data acquisition unit, and
estimates the position posture of the identification member based on the specified three-dimensional coordinates.

12. The three-dimensional scanner according to claim 11, wherein the estimation unit specifies the three-dimensional coordinates indicating the region where the identification member is present by acquiring three-dimensional information at coordinates corresponding to the two-dimensional coordinates from the first three-dimensional data generated by the three-dimensional data generation unit based on the light reception signal output by the first camera and acquired by the data acquisition unit.

13. The three-dimensional scanner according to claim 11, wherein coordinates of the first camera and coordinates of the second camera are associated with each other based on an internal parameter of the first camera, an internal parameter of the second camera, and an external parameter of the second camera with respect to the first camera.
